(19) United States
(12) Patent Application Publication
(10) Pub. No.: US 2013/0306399 A1
(43) Pub. Date: Nov. 21, 2013

(54) Customizable Modular Speaker System

(71) Applicants: Christopher Swan, Templeton, CA (US); Jonathan Hart, Salt Lake City, UT (US); Kaweath W. Swan, Templeton, CA (US)

(72) Inventors: Christopher Swan, Templeton, CA (US); Jonathan Hart, Salt Lake City, UT (US); Kaweath W. Swan, Templeton, CA (US)

(21) Appl. No.: 13/982,692

(22) PCT Filed: Jan. 31, 2012
(86) PCT No.: PCT/US12/23299

§ 371 Date: Jul. 30, 2013

Related U.S. Application Data
(60) Provisional application No. 61/438,172, filed on Jan. 31, 2011.

(51) Int. Cl. H04R 1/02

(52) U.S. Cl. CPC H04R 1/02
USPC 181/199

(57) ABSTRACT

A customizable modular speaker system. The system includes one or more acoustic modules; one or more optional spacer modules coupled to the acoustic modules; and one or more end caps that can be coupled to the acoustic or spacer modules. The modules and endcaps, when assembled, formed a substantially continuous T-slot. The T-slot is capable of engaging a wall mounting cradle which in turn can affix the speaker to a surface with a mounting bracket to create a wall mounted speaker. In other instances, where a shelf or tower speaker is desired, the T-slot engages a spine mounted in a base. The present modular system allows for the same components to be assembled into a bookshelf speaker, a tower speaker, a sound bar, or a wall speaker.

### PRIORITY STATEMENT

This application claims priority to U.S. Application Ser. No. 61/438172, filed Jan. 31, 2011 which is hereby incorporated by reference for its supporting teachings.

### BACKGROUND

Customized speaker systems are desirable in a variety of settings. For example home theaters, gaming systems and indoor or outdoor entertainment systems, depending on the layout of the space, require different speaker quantities, configurations and orientations in order to maximize sound quality. Customization is also required to fit speaker systems in with existing components, structure, architecture, etc.

The present invention in its various embodiments provides a modular speaker system that is not only easier to install, but is also easy to customize to a variety of situations, needs and desires. Additionally, by having module uniformity, the modules have similar tonal characteristics—which provides a balanced system, no matter the combination.

The foregoing advantages, as well as others, are realized in the present invention in its various embodiments.

### SUMMARY

The present invention in its various embodiments is a customizable modular speaker system. The system includes one or more acoustic modules; one or more optional spacer modules coupled to the acoustic modules; and one or more end caps that can be coupled to the acoustic or spacer modules. The modules and endcaps, when assembled, form a substantially continuous T-slot. This T-slot is capable of engaging a wall mounting cradle which in turn can affix the speaker to a surface with a mounting bracket to create a wall mounted speaker. In other instances, where a shelf or tower speaker is desired, the T-slot engages a spine mounted in a base. The base can includes one or more electrical connectors capable of relaying an electrical signal from an amplifier to the acoustic modules. The present modular system allows for the same components to be assembled into a bookshelf speaker, a tower speaker, a sound bar, or a wall speaker. In some instances, the modules can include a removable covering. The covering, which can be a grill, can be attached through a substantially continuous groove in the modules. The acoustic modules, spacer modules and end caps can be connected with one or more snap lock assemblies.

### BRIEF DESCRIPTION OF THE DRAWINGS

FIG. 1 is a front perspective view of an acoustic module of a customizable speaker system according to one embodiment of the present invention.

FIG. 2 is a side view of the acoustic module of FIG. 1.

FIG. 3 is a front view of the acoustic module of FIG. 1.

FIG. 4 is a top view of the acoustic module of FIG. 1.

FIG. 5 is a front perspective view of an acoustic module of a customizable speaker system according to one embodiment of the present invention.

FIG. 6 is a front view of the module of FIG. 5.

FIG. 7 is a side view of the module of FIG. 5.

FIG. 8 is a backside view of an acoustic module according to one embodiment of the present invention.

FIG. 9 is a front perspective view of a spacer module according to one embodiment of the present invention.

FIG. 10 is a front view of the module of FIG. 9.

FIG. 11 is a side view of the module of FIG. 9.

FIG. 12 is a top view of the module of FIG. 9.

FIG. 13 is a rear view of the module of FIG. 9.

FIG. 14 is a spacer module according to one embodiment of the present invention.

FIG. 15 is a front perspective view of a spacer module according to one embodiment of the present invention.

FIG. 16 is a front view of the module of FIG. 15.

FIG. 17 is a side view of the module of FIG. 15.

FIG. 18 is a front view of an end caps of a customizable speaker system according to one embodiment of the present invention.

FIG. 19 is a side view of the end cap of FIG. 18.

FIG. 20 is a front perspective of an end cap according to one embodiment of the present invention.

FIG. 20 is a top view of an end cap according to one embodiment of the present invention.

FIG. 22 is a wall mounting device cradle according to one embodiment of the present invention.

FIG. 23 is a side view of the cradle of FIG. 22.

FIG. 24 is s front view of a cradle mounting system according to one embodiment of the present invention.

FIG. 25 is a side sectional view of the cradle of FIG. 24.

FIG. 26 is a back side view of a cradle according to one embodiment of the present invention.

FIG. 27 is a mounting bracket according to one embodiment of the present invention.

FIG. 28 is a depiction of a wall mounting assembly according to one embodiment of the present invention.

FIG. 29 shows three angular orientations of a wall mounting system.

FIG. 30 shows a front perspective view of a spine component according to one embodiment of the present invention.

FIG. 31 shows a front view of the spine component of FIG. 30.

FIG. 32 shows a side view of the spine component of FIG. 30

FIG. 33 shows a front view of a spine component according to one embodiment of the present invention.

FIG. 34 shows a cross sectional view of a spine component according to one embodiment of the present invention.

FIG. 35 depicts a front perspective view of a base according to one embodiment of the present invention.

FIG. 36 is a front view of the base of FIG. 35.

FIG. 37 is a backside view of a base according to one embodiment of the present invention.

FIG. 38 shows two side views of a base according to one embodiment of the present invention.

FIG. 39 is a front perspective view of a base according to one embodiment of the present invention.

FIG. 40 is a front view of the base of FIG. 39.

FIG. 41 is a backside view of a base according to one embodiment of the present invention.

FIG. 42 shows a disassembled shelf speaker according to one embodiment of the present invention.

FIG. 43 shows a front perspective view of an assembled shelf speaker according to one embodiment of the present invention.

FIG. 44 shows a rear view of the shelf speaker of FIG. 43.

FIG. 45 shows a side view of the shelf speaker of FIG. 43.

FIG. 46 shows a sectional view of the shelf speaker of FIG. 45.

FIG. 47 shows a bottom view of a speaker assembly according to one embodiment of the present invention.

FIG. 48 shows a bottom view of a speaker assembly according to one embodiment of the present invention.

FIG. 49 shows a front perspective view of a tower speaker assembly according to one embodiment of the present invention.

FIG. 50 shows a front perspective view of a sound bar assembly according to one embodiment of the present invention.

FIG. 51 shows a front view of the sound bar of FIG. 50.

FIG. 52 shows a front view of a connection mechanism according to one embodiment of the present invention.

FIG. 53 shows a front perspective view of a disassembled sound bar according to one embodiment of the present invention.

FIG. 54 shows a front view of a disassembled sound bar according to one embodiment of the present invention.

FIG. 55 shows a top view of a disassembled sound bar.

FIG. 56 shows a sectional view of the sound bar of FIG. 55.

FIG. 57 shows a front view of a disassembled sound bar according to one embodiment of the present invention.

FIG. 58 shows a front perspective view of a sound bar according to one embodiment of the present invention.

FIG. 59 shows a front view of the sound bar of FIG. 58.

FIG. 60 shows a front perspective of a wall speaker according to one embodiment of the present invention.

FIG. 61 shows a front view of the speaker of FIG. 60.

FIG. 62 shows a front perspective view of a disassembled wall speaker according to one embodiment of the present invention.

FIG. 63 shows a rear perspective view of a disassembled wall speaker according to one embodiment of the present invention.

FIG. 64 shows a side view of a disassembled wall speaker according to one embodiment of the present invention.

FIG. 65 shows a side view of a wall speaker according to one embodiment of the present invention.

FIG. 66 shows a top view of a wall speaker according to one embodiment of the present invention.

FIG. 67 illustrates the continuity of the T-slot in the modular speaker system according to one embodiment of the present invention.

FIG. 68 shows sectional views of the speaker system of FIG. 67.

FIG. 69 depicts an exemplary wiring configuration for speaker assemblies according to one embodiment of the present invention.

FIG. 70 depicts an exemplary wiring configuration for speaker assemblies according to one embodiment of the present invention.

FIG. 71 depicts an exemplary wiring configuration for speaker assemblies according to one embodiment of the present invention.

FIG. 72 depicts an exemplary wiring configuration for speaker assemblies according to one embodiment of the present invention.

FIG. 73 depicts an array module according to one embodiment of the present invention.

### DETAILED DESCRIPTION OF THE ILLUSTRATED EMBODIMENTS

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

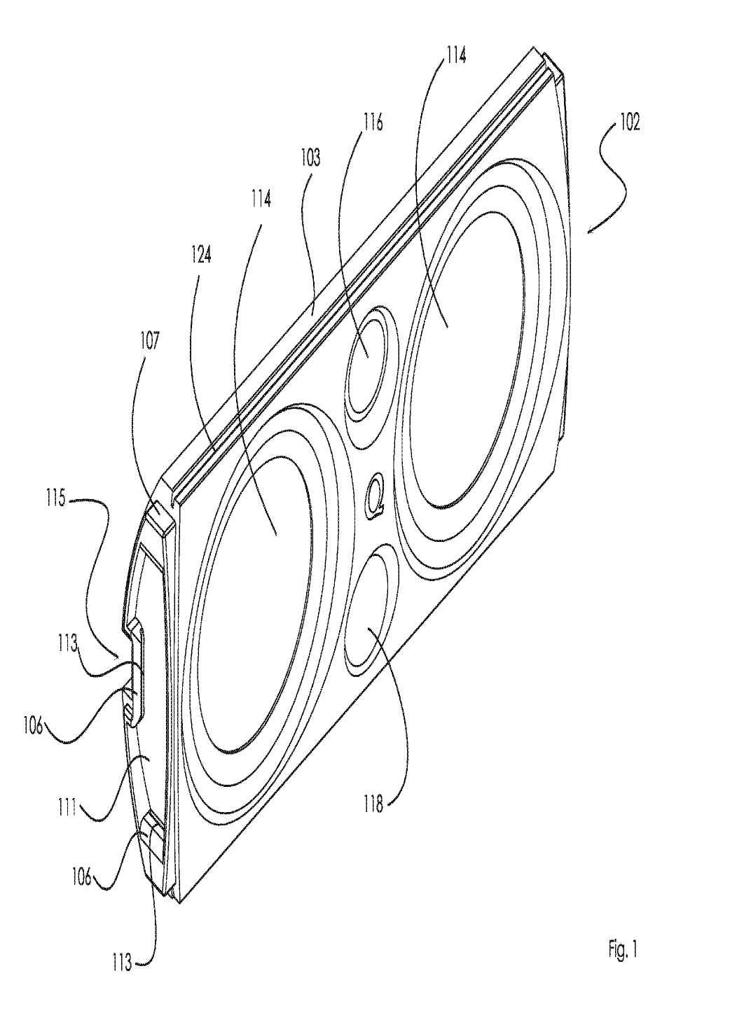

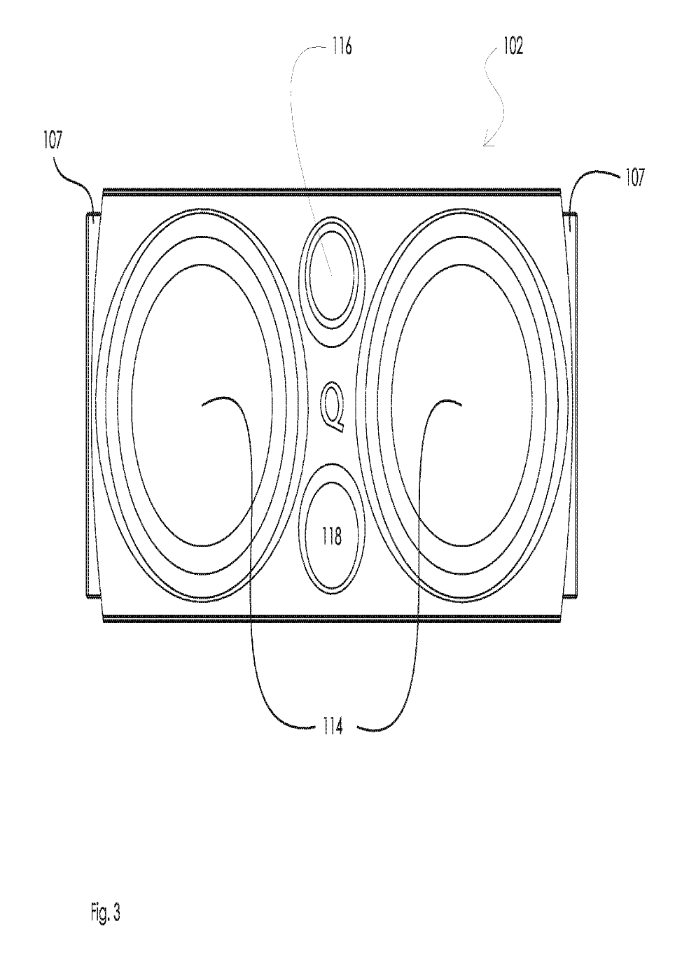

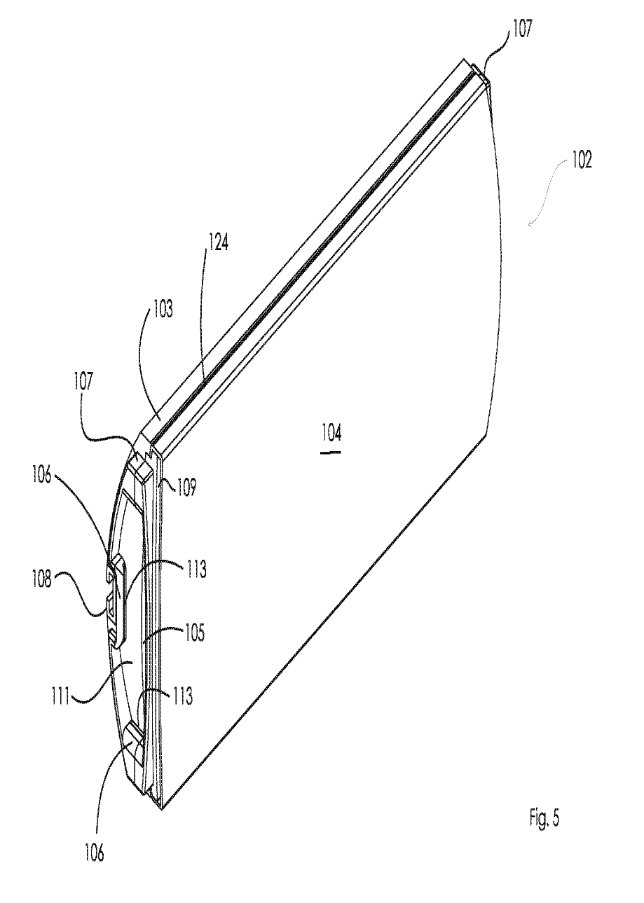

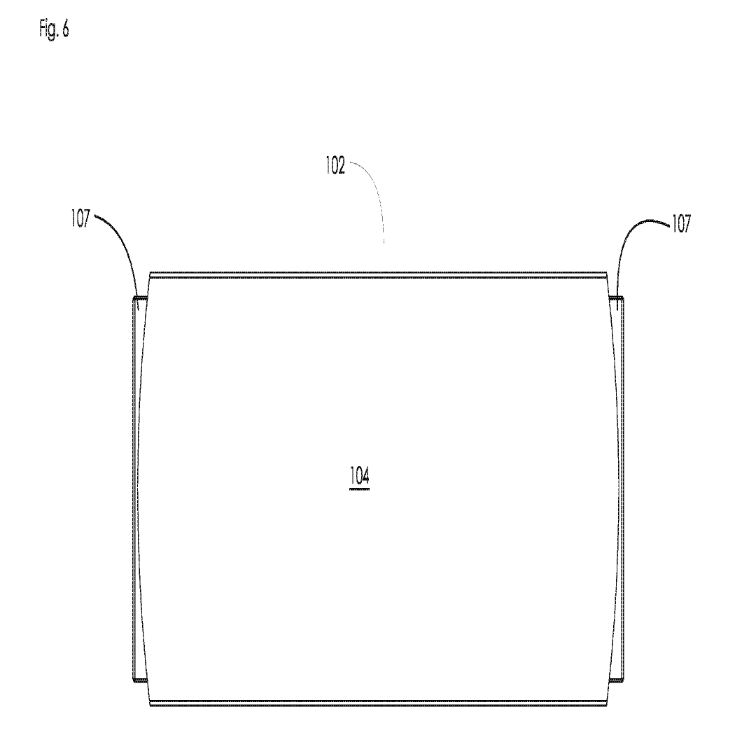

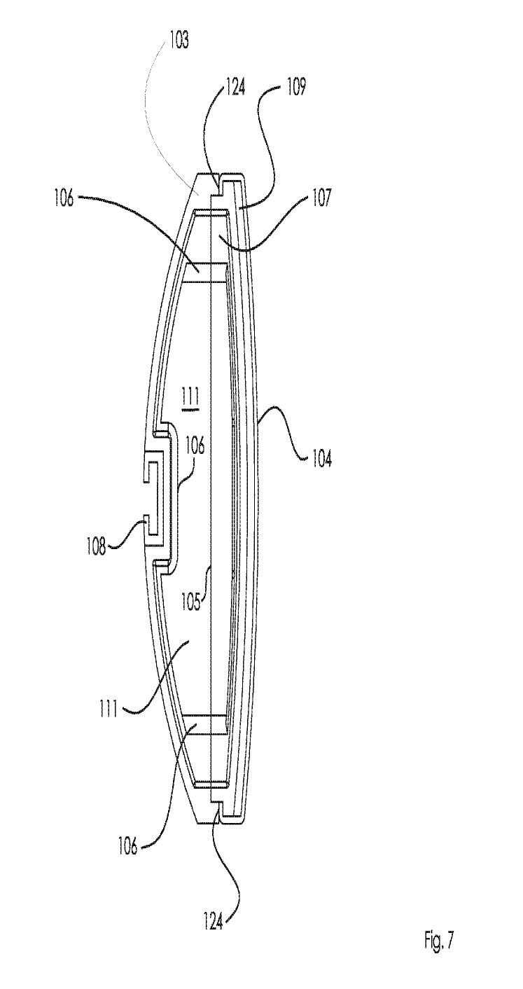

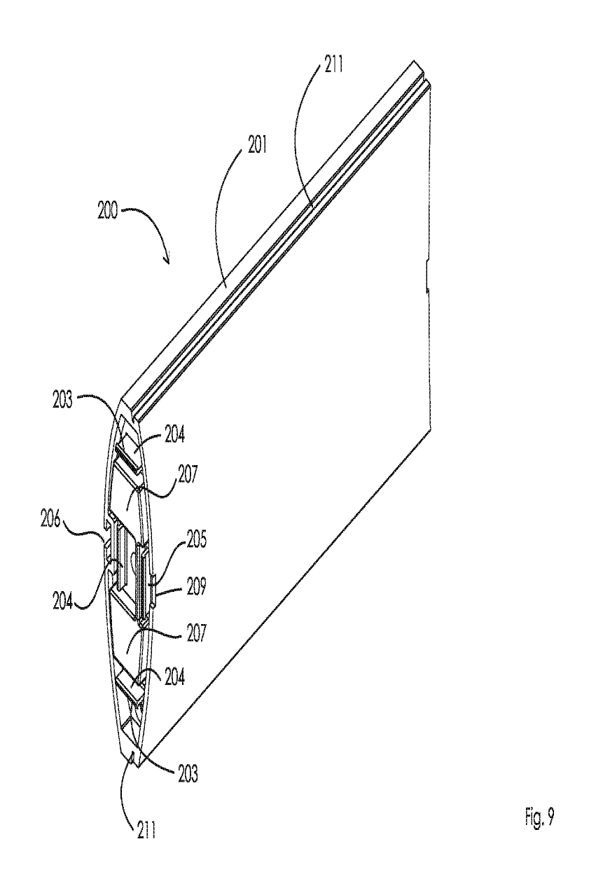

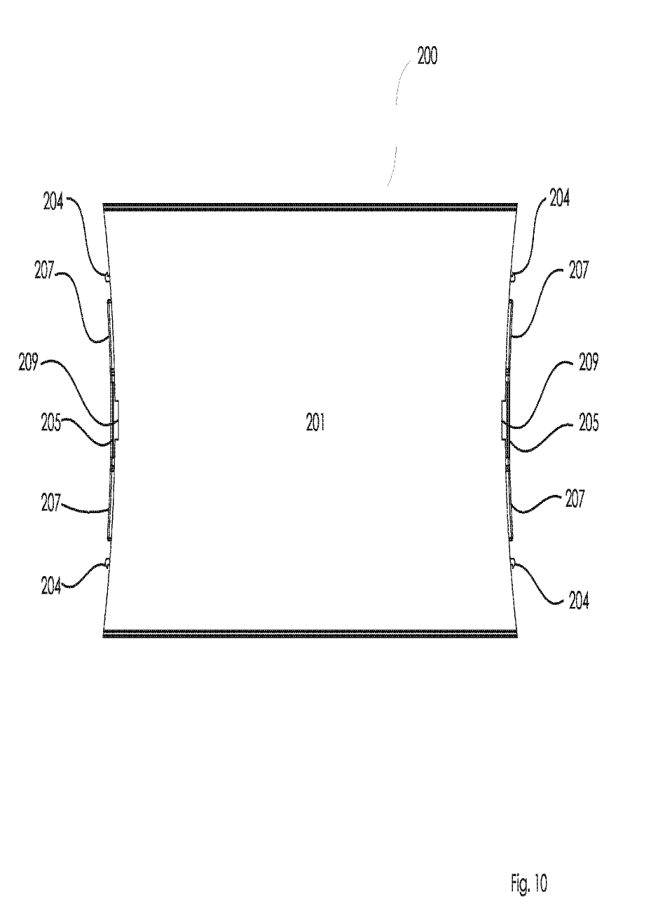

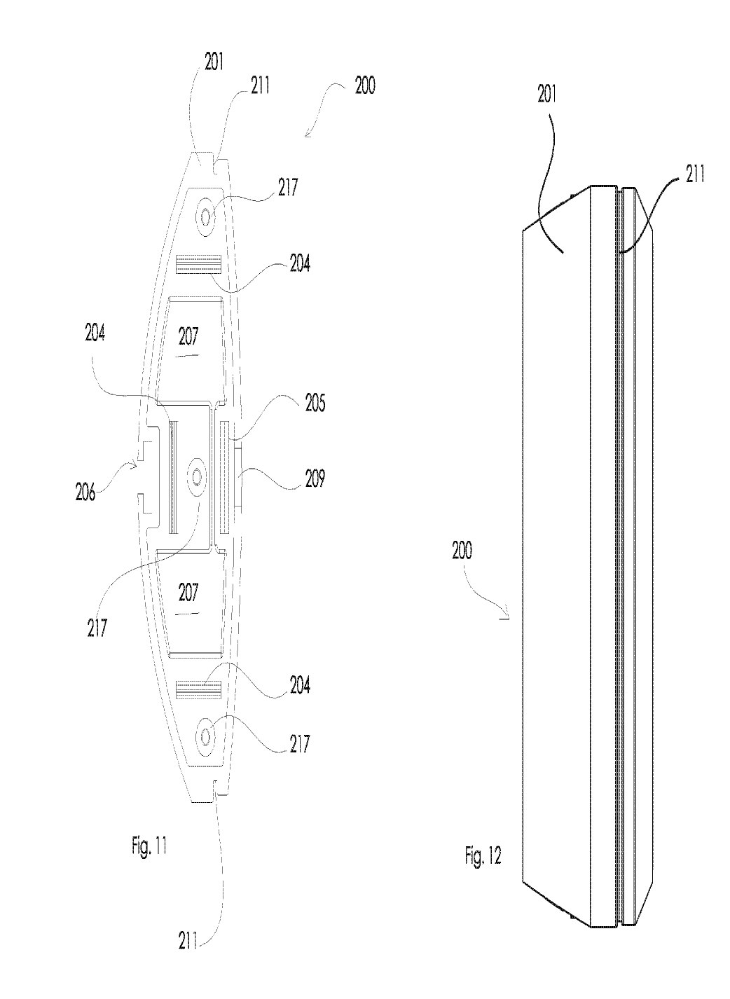

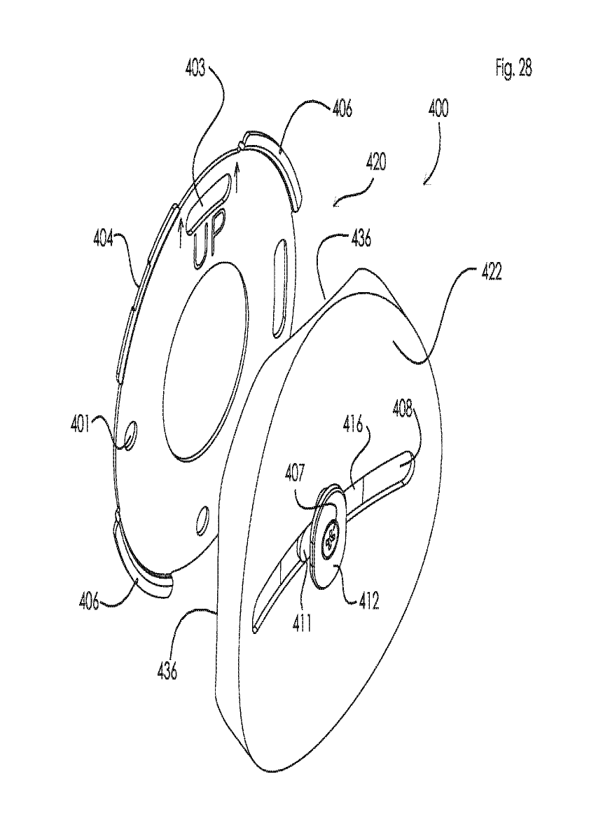

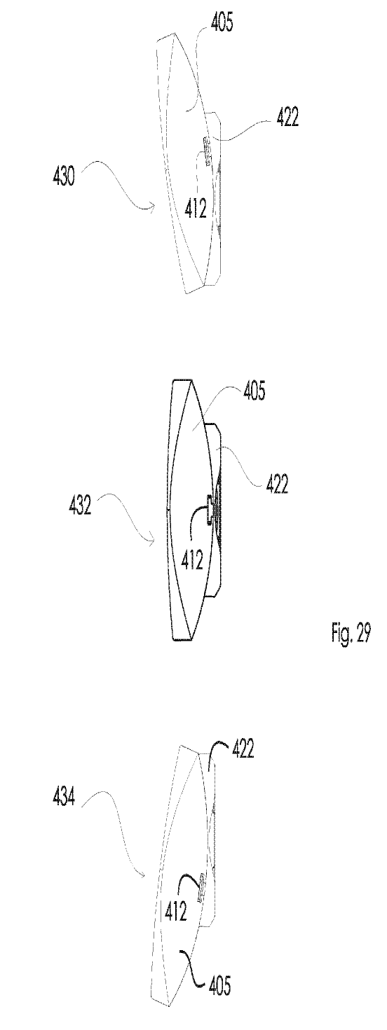

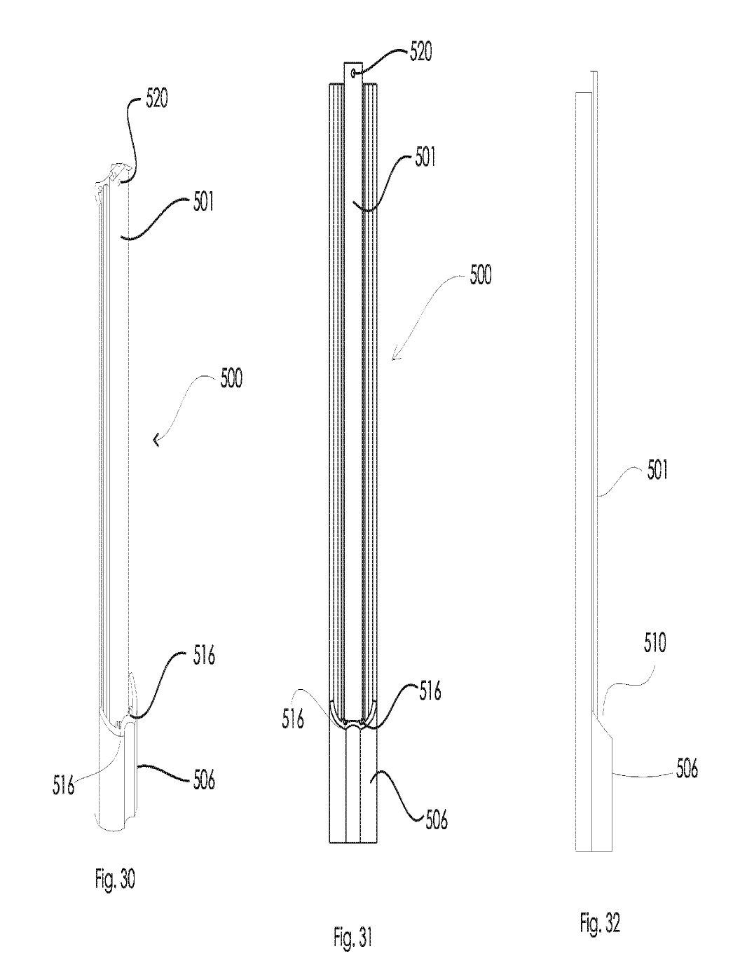

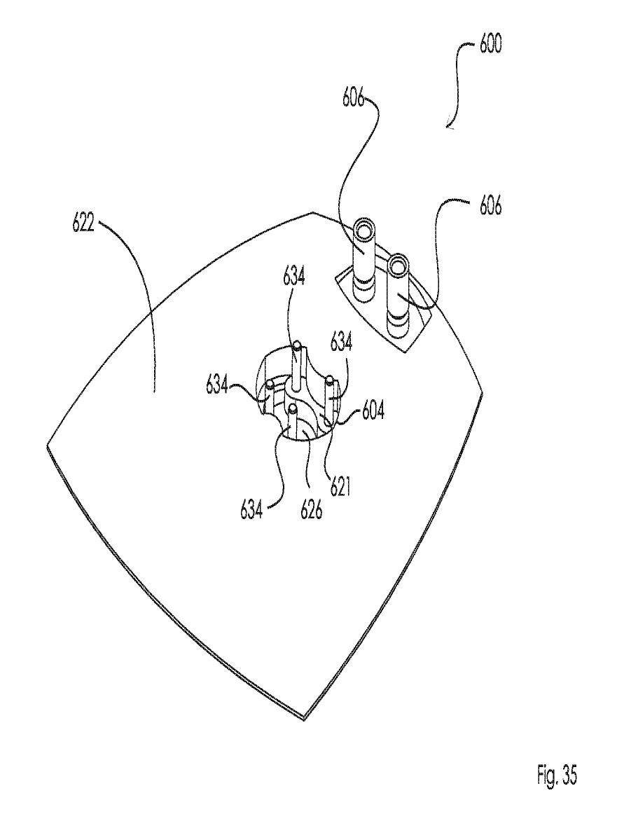

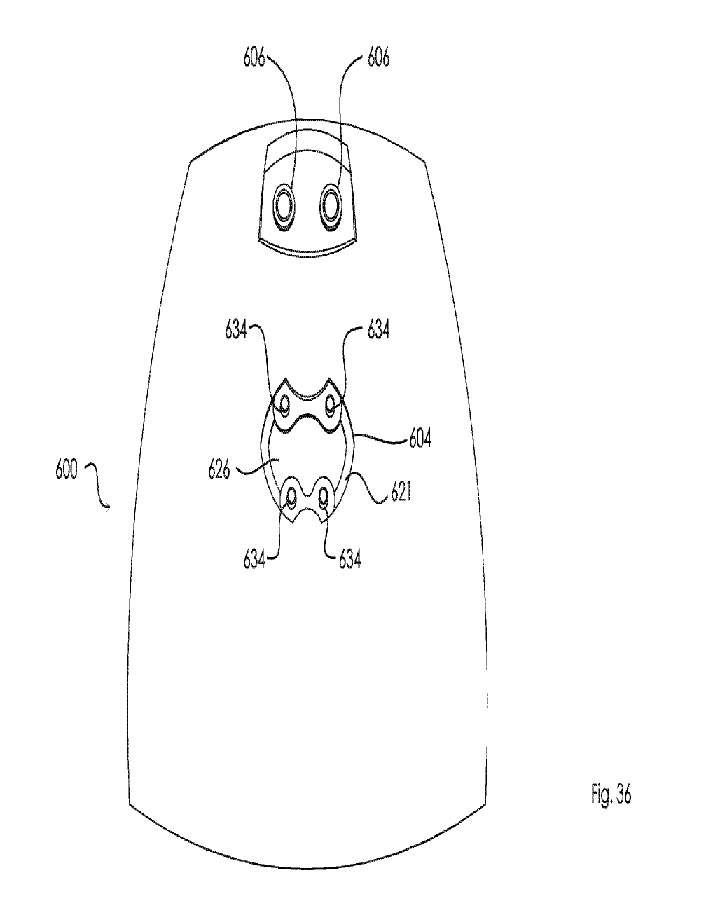

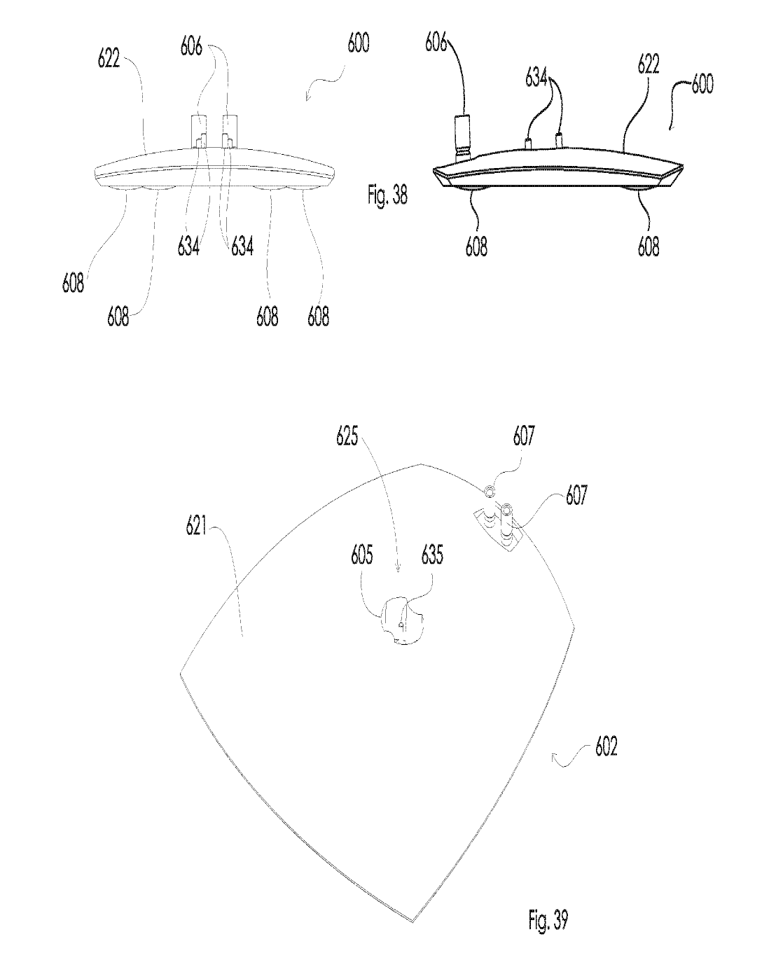

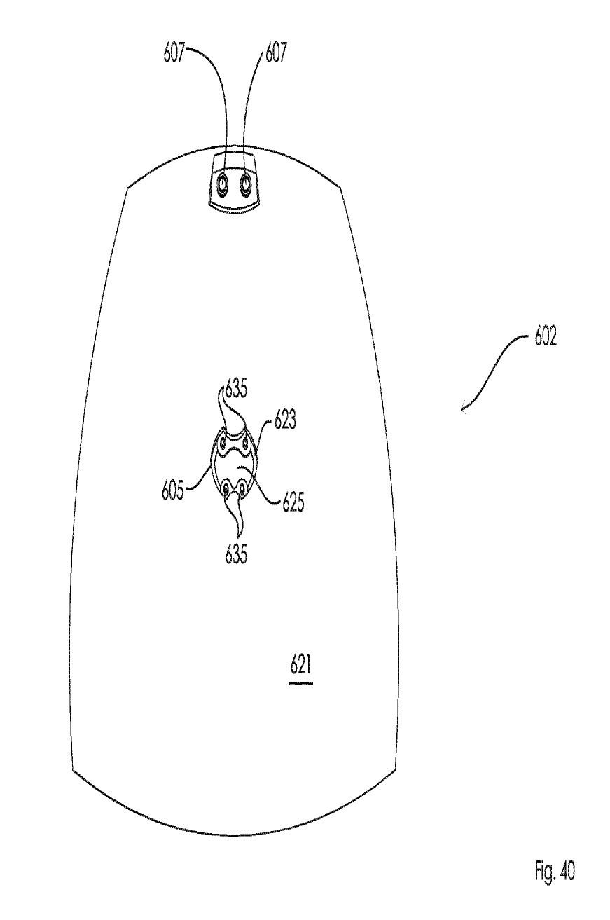

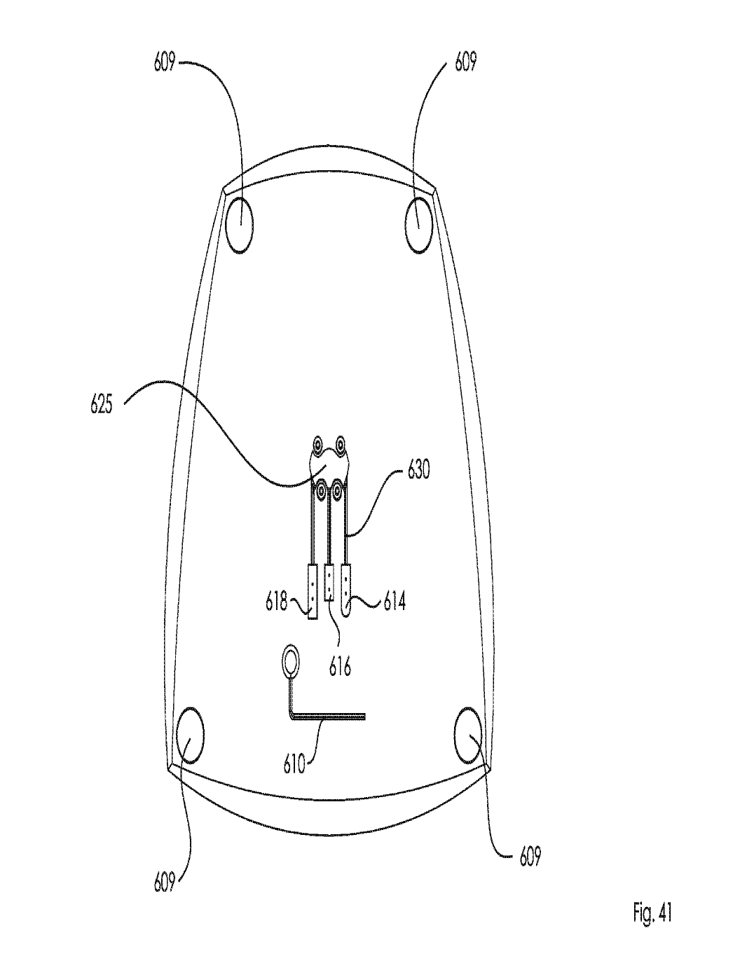

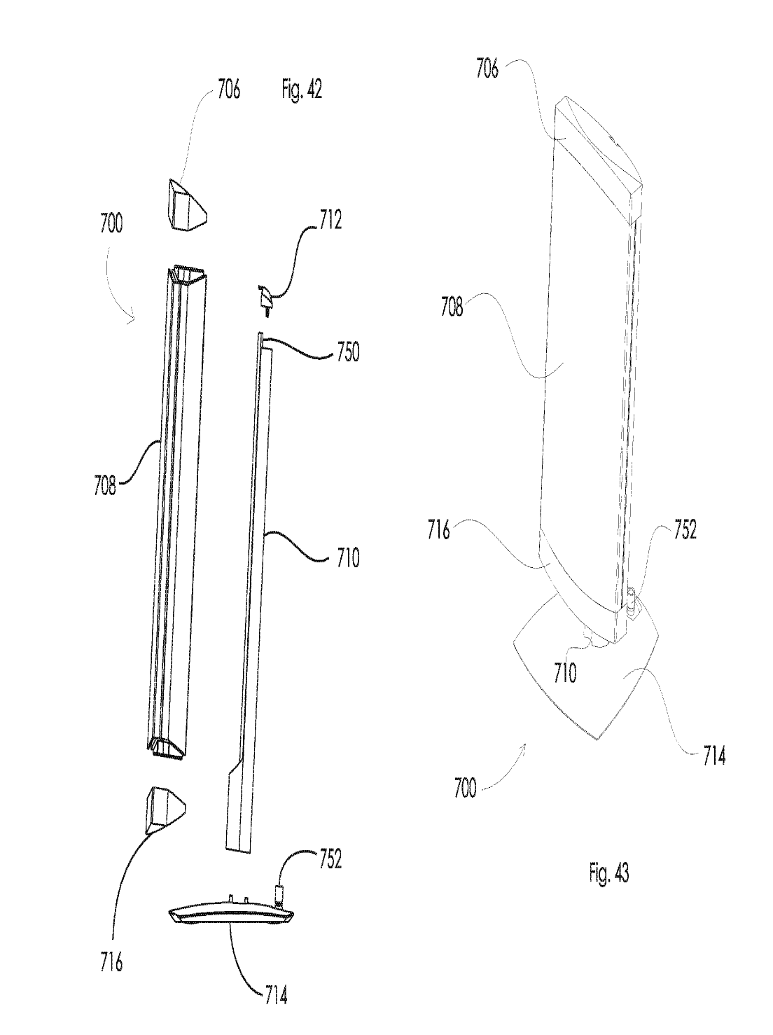

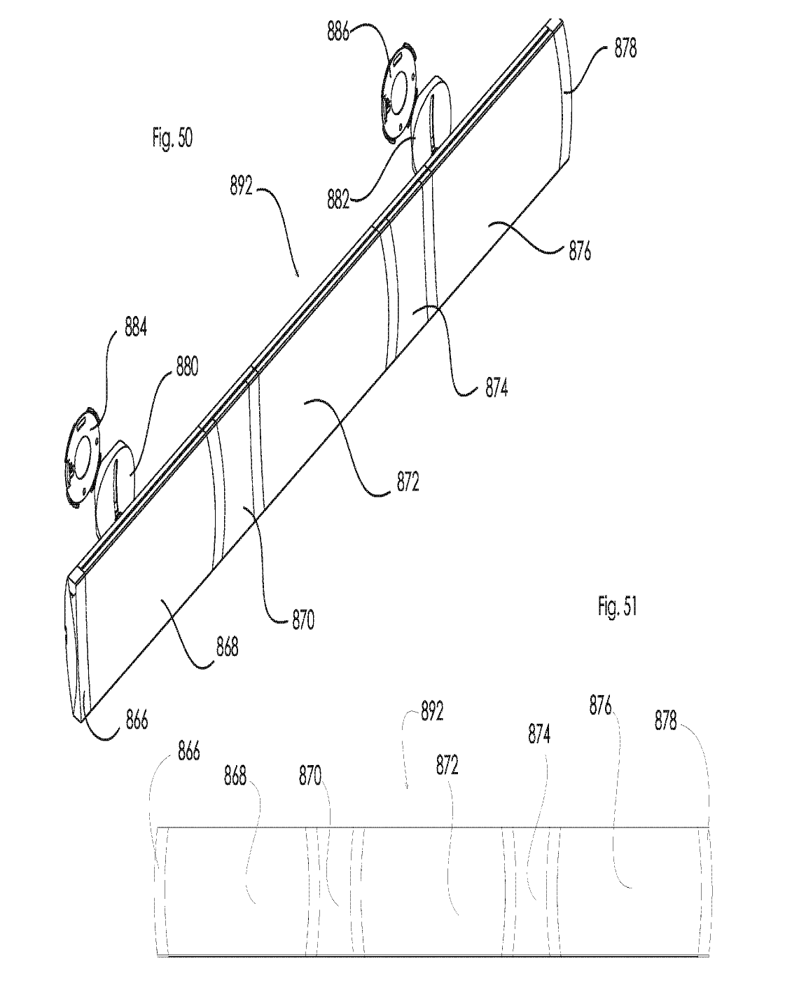

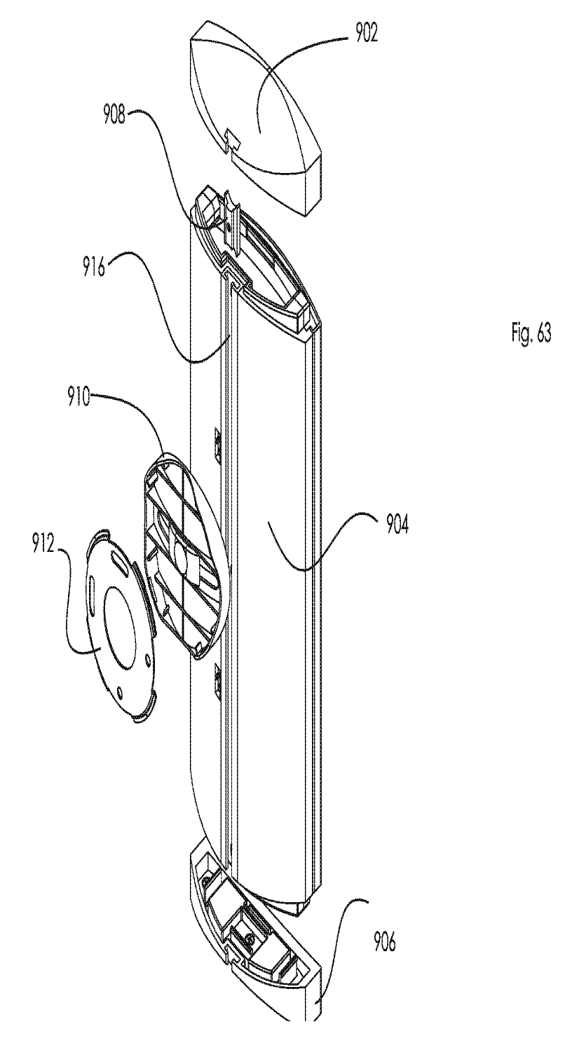

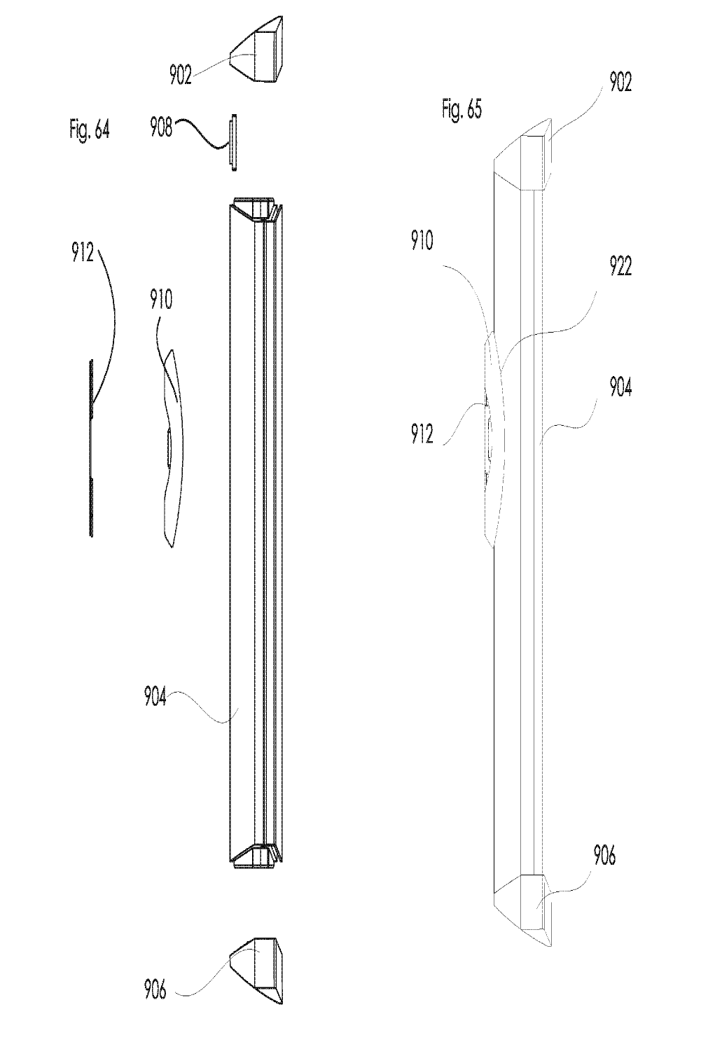

The system described is a modular speaker system. The system is based on several core modules, including an acoustic module 102 (FIGS. 1-8), a spacer module 200 (FIGS. 9-17), an end cap 300 (FIGS. 18-21), a wall mount 400 (FIGS. 22- 29), a spine 500 (FIGS. 30-34), and a base 600 (FIGS. 35-41). These modules can be combined in various ways to create several different speakers including, but not limited to, a bookshelf speaker 700, a tower speaker 702 (FIGS. 42-49), a sound bar 850 (FIGS. 50-59), and an on wall speaker 900 (FIGS. 60-66).

Referring to FIGS. 1-4, an acoustic module 102 is shown according to one embodiment of the present invention. The module 102 includes an outer casing 103. In this embodiment, the casing 103 can be made of a variety of materials including but not limited to ABS, PP, PC, Nylon, aluminum, wood, mdf and combinations thereof.

The acoustic module 102 can include various mechanisms that allow it to be connected with other modules. For example, in the presently illustrated embodiment, casing 103 includes protrusions 107 on both sides that are fitted to mate with other modules. The protrusion 107 defines a walled space 111 and includes one or more integrated snap locks 106. As best seen in FIG. 1, the snap locks 106 include a groove 113 that corresponds to tab locking mechanisms on other modules (discussed below). It is noted that, in addition to snap locks, the modules could be connected with other types of connection mechanisms including but not limited to magnets, bolts, or press fits or combinations thereof.

In this embodiment, the protrusion 107 is molded as part of the casing 103. However, in other embodiments, it could be separately fastened to the casing 103. Similarly, the snap locks 106 are shown as being integrated, but could likewise be separately fastened to casing 103.

The acoustic modules 102 shown in the presently illustrated embodiments include two woofers 114, one tweeter 116, and one port 118. Any number of industry standard woofers, as are readily available, would be suitable for use with the present invention. Likewise, any number of industry standard tweeters, as are readily available, would be suitable for use with the present invention.

The acoustic module 102 may be configured using any combination of these features depending on user need and/or desire. For instance, a bass module may be created by eliminating the tweeter 116. Likewise, a midrange unit may be created by eliminating the port 118. A stereo unit may be created by using a coaxial driver in place of woofers 114.

Numerous other configurations would be apparent to one skilled in the art.

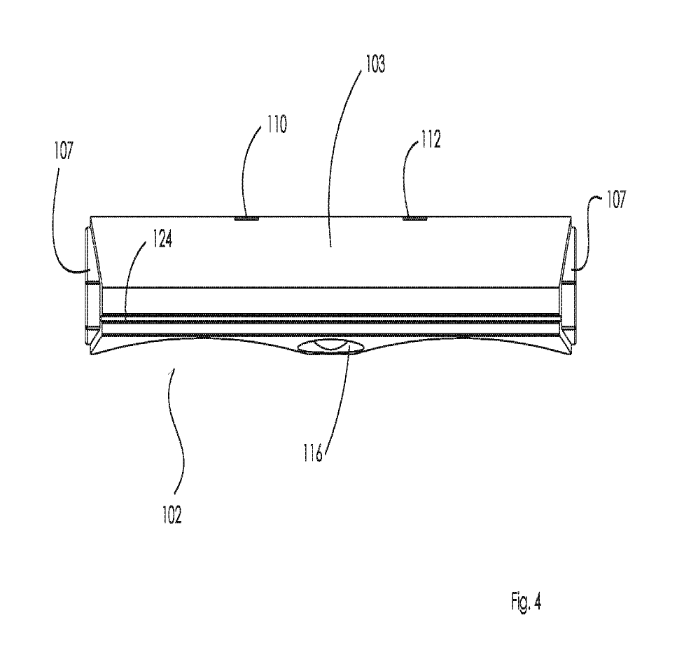

The casing 103 can include one or more grooves 124. As seen in FIGS. 5-7, the grooves 124 are able to securely accommodate a module covering 104. In this embodiment, the acoustic module covering 104 is a grill. However, other covering types that would be suitable for use with the present invention include, but are not limited to cloth, plastic or metal mesh of any perforation pattern. It is also noted that these variations in covering types could apply to the other modules discussed herein.

The covering 104 in this embodiment is a hard plastic mesh that protects the internal speaker components from damage. The covering 104 can be made of numerous other materials including, but not limited to ABS, Nylon, PP, perforated aluminum, steel, or stainless steel or combinations thereof. It could also utilize various patterns including, but not limited to meshes, arrays of punched circles, squares, hexagons, or any geometric shape, a series of linear elements, or a random pattern of cutouts. The covering 104 can serve a cosmetic purpose and can also include cloth coverings.

In FIGS. 5 and 7, there is a small space 109 between the back surface of the covering 104 and the casing 103. This provides additional protection for the internal components of the modules 102. In some embodiments, additional space may be desirable; in other embodiments, less space may be desirable. In yet other embodiments, the covering 104 may be substantially flush with the casing 103.

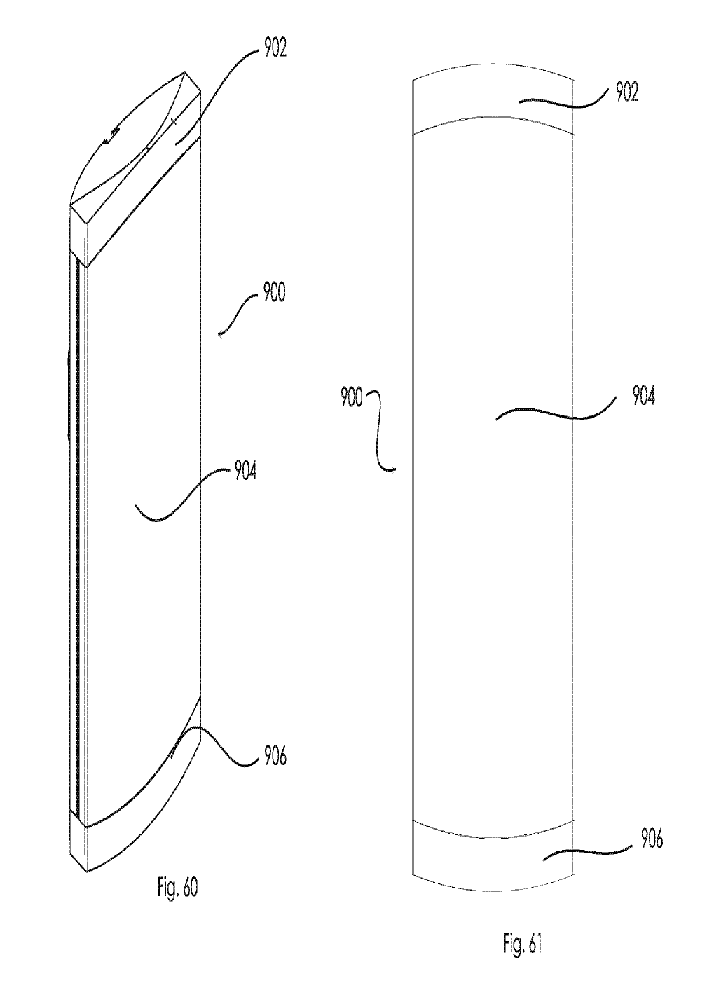

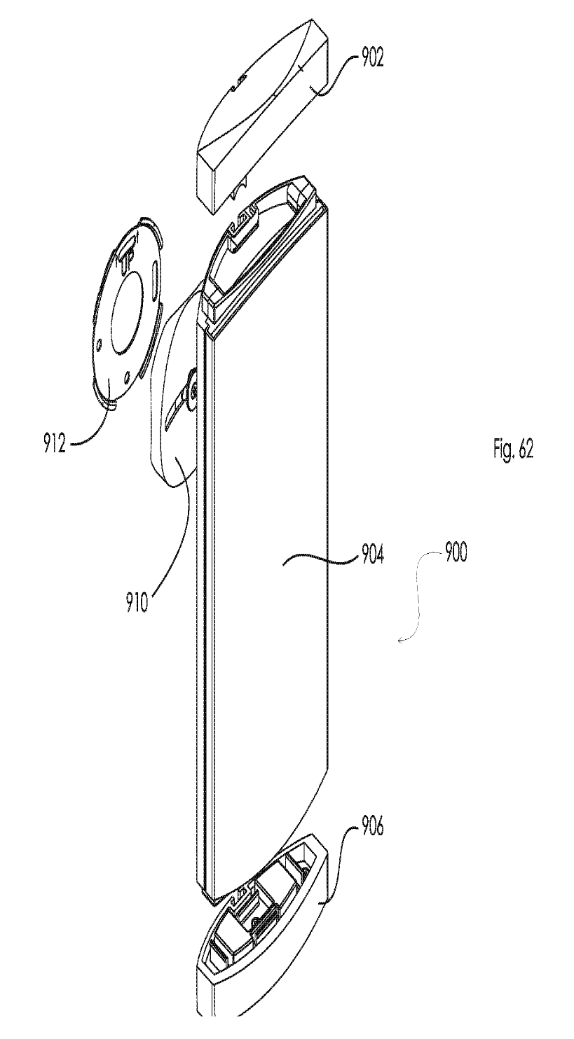

Depending on need and desire, in some instances it may be desirable to include the covering 104. However, in some instances, the covering may be eliminated. In yet other cases, combinations of the two may be wanted—i.e. partly covered, partly exposed. In yet other instances, a customized covering rather than the modular covering 104 as depicted in FIGS. 5-7 may be desirable. For example, a full length covering may be desirable for a sound bar configuration (as depicted in FIGS. 58 and 59). It is noted that by having the groove 124 run the full length of all modules, a variety of covering configurations can be utilized.

In this embodiment the grooves 124 are simply channels in the acoustic module casing 103 that correspond to the upper and lower edges of the covering 104. However, the covering 104 could be attached to the module 102 in a variety of other ways including, but not limited to screws, magnets, or a press fit groove.

Each acoustic module 102 includes a full length T-slot 108 for use with various mounting mechanisms. In the present embodiment, the full length T-slot 108 runs from end to end, and couples with other modules to form a continuous T-slot as shown at 1000 (FIG. 67).

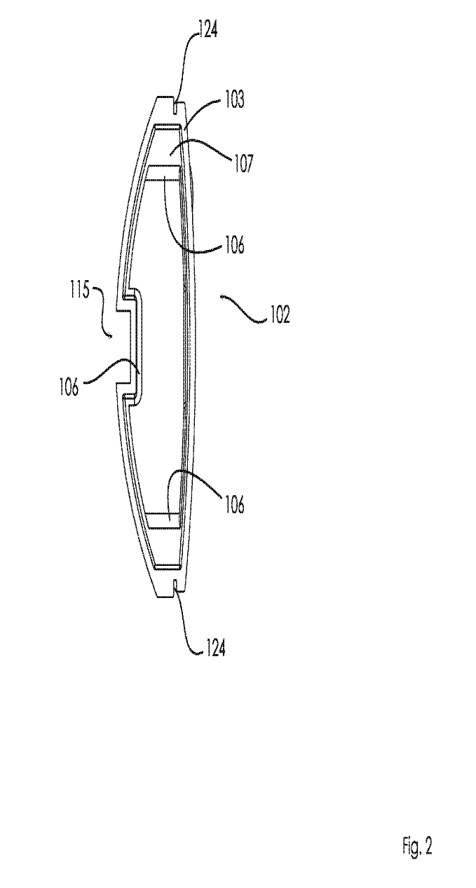

In certain embodiments, the T-slot 108 is preformed and then inserted into space 115 (FIGS. 1 and 2) and can then be secured to the casing 103 with screws or other known securing mechanisms 117 (FIG. 8). However, in other instances, it may be desirable to have the T-slot 108 integrated into the casing when formed. The T-slot 108 can be made of the same materials as the casing 103. It is noted that when referring to a T-slot herein, the invention is not intended to be limited to a particular cross-sectional configuration that has a T-shape. Rather a T-slot is intended to include any geometric shape extruded along the length of the speaker including, but not limited to, a circle, triangle, square, or complex polygon. It is also noted that in FIGS. 5 and 7, the casing 103 is shown as two pieces connected at seam 105. This allows for easy insertion of the speaker components during assembly. However, it is noted that in other embodiments, the casing 103 could be more than two pieces or it could be a single piece.

Referring now to FIG. 8, each acoustic module 102 includes input connectors 110, 112. Suitable input connectors include but are not limited to custom inputs, euro style inputs, Neutrik connectors, ¼″ or ⅛″ barrel connectors, spring terminals, screw terminals, RCA connectors, or binding posts. In some instance, it may be desirable to have the connectors 110, 112 custom designed depending on need. The connectors 110, 112 can be joined internally for a mono module, or run independently to drivers (e.g. woofers 114, tweeters 116 or ports 118) to provide stereo within a single unit.

Referring now to FIGS. 9-14, a spacer module 200 is shown according to one embodiment of the present invention. The spacer module 200 is designed to create separation between other modules and can be any width as dictated by need or desire.

The spacer 200 in this embodiment includes a casing 201. The casing 201 can be made of a variety of materials including but not limited to aluminum, ABS, PP, Nylon, PC, PE or combinations thereof. The spacer 200 includes connection mechanisms that correspond to the snap locks 106 in the acoustic modules 102 (e.g. FIG. 5). In this embodiment, the connection mechanisms are a series of tabs 204 having latching ends 203. In FIG. 9, the latching ends 203 are oriented in opposite directions relative to one another—i.e. the top tab's latching end 203 points upward; while the bottom tab's latching end 203 points downward. However, in other embodiments, it may be desirable to have the orientation be in the same direction.

Additional tabs can also be included to further secure the modules together. For example, latching tab 205 connects with corresponding slots in the acoustic module similar to those discussed above. Anchoring devices 207 corresponding with space 111 in the acoustic module 102 can help minimize movement of the modules when connected. The spacer 200 also includes opening 209 into which a standard flat blade screwdriver or other similar tool can be inserted. The action of twisting the screwdriver serves to cause tabs 204, 205 to disengage from their corresponding slots. This allows for the modules to be disconnected if desired.

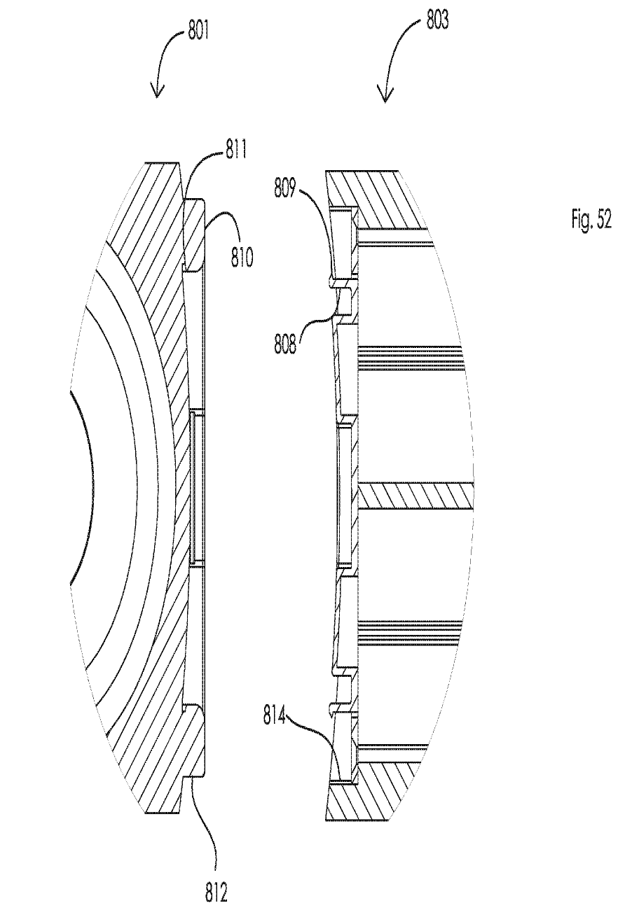

To illustrate the connection mechanism provided by the snap locks 106 and latching tabs 204, reference is made to FIG. 52. In this embodiment, an acoustic module 801 having a snap locking mechanism 810 is shown. A spacer 803 having a latching tab 808 is also shown. When the two modules are pressed together, the tab 808 has a certain amount of pliability and bends downward until latching end 809 comes into contact with groove 811 at which point, tab 808 rebounds and the positioning of end 809 in groove 811 holds modules together until latching end 809 of tab 808 is pressed downward or otherwise disengaged from groove 811.

The snap lock 106 and latching tab 204 assembly allows the joining of a plurality of modules in various configurations. In some embodiments, the relative positioning of the snap locks and latching tabs may be reversed (e.g. the snap locks could be on the spacer module and the tab on the acoustic module). It is also noted that while the snap lock assemblies are advantageous, other connection mechanisms could be employed including, but not limited to magnets, screws, and a press fit.

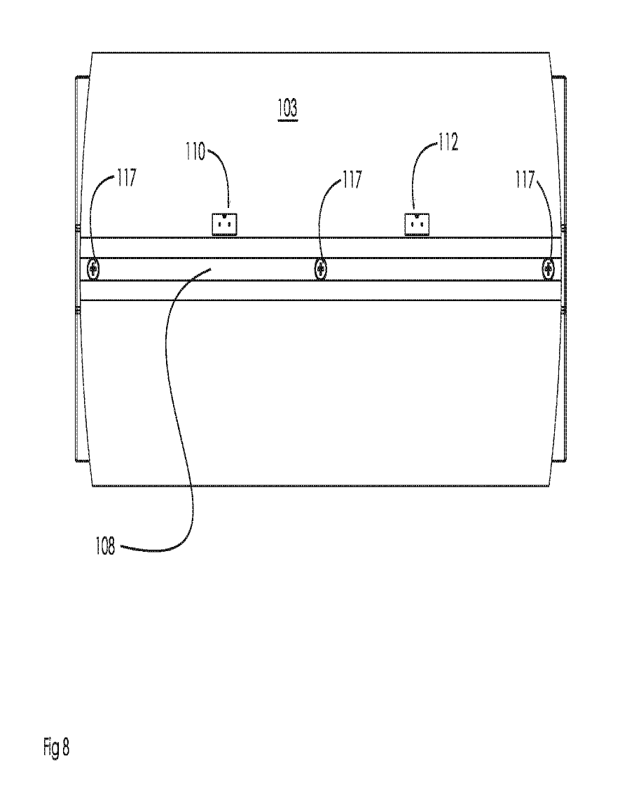

In certain embodiments, the snap locking mechanisms will be made of different materials than the rest of the module. For example, in FIG. 11, the snap locking assembly is plastic and the spacer is made of aluminum. Fasteners 217, such as screws, that secure the plastic snap components to the aluminum spacer module. Similar mechanisms could be employed for the other modules—e.g. acoustic modules and end caps. It is also noted that, in other embodiments, such fasteners 217 may not be necessary as the snap locking assembly is the same material as the rest of the module and as such can be manufactured as an integrate piece.

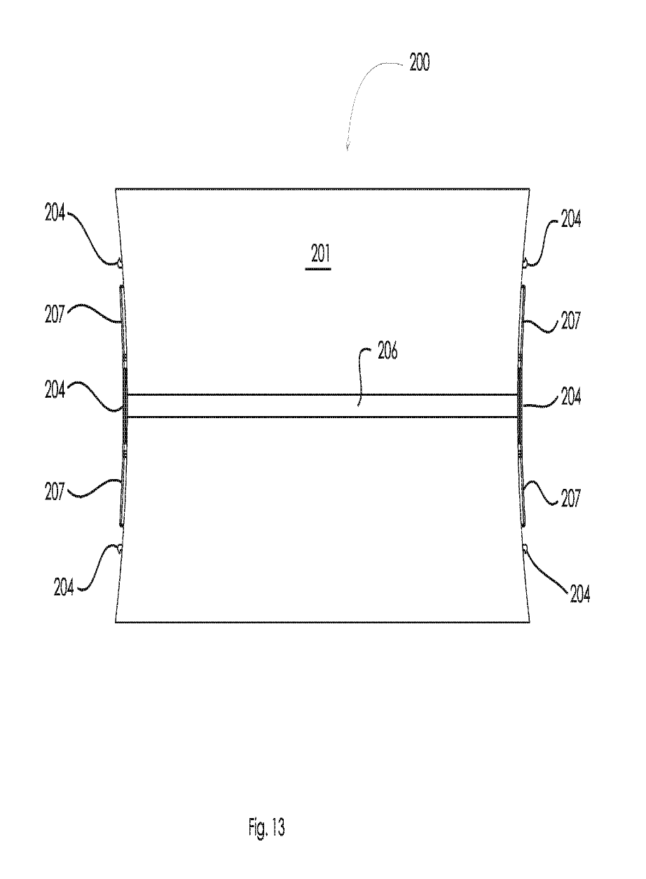

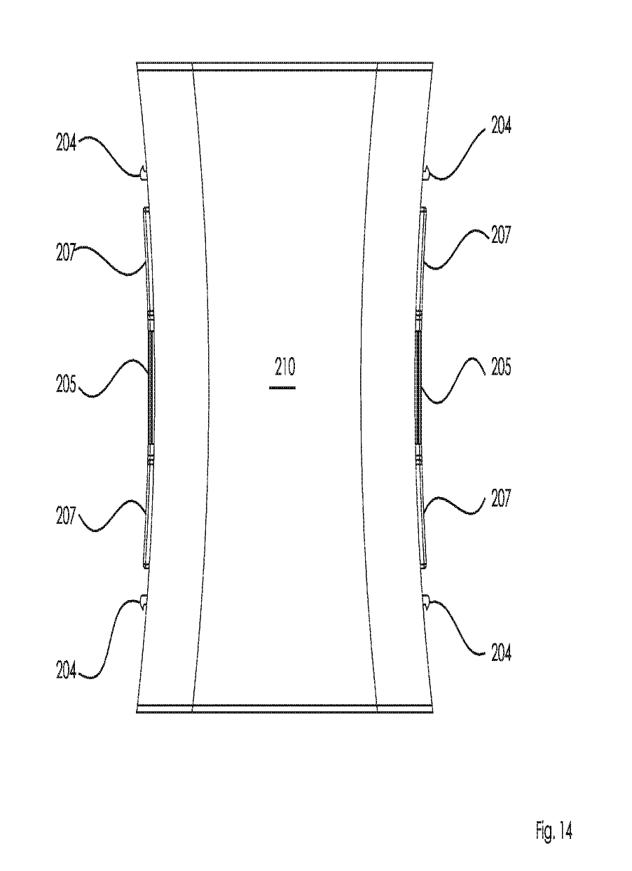

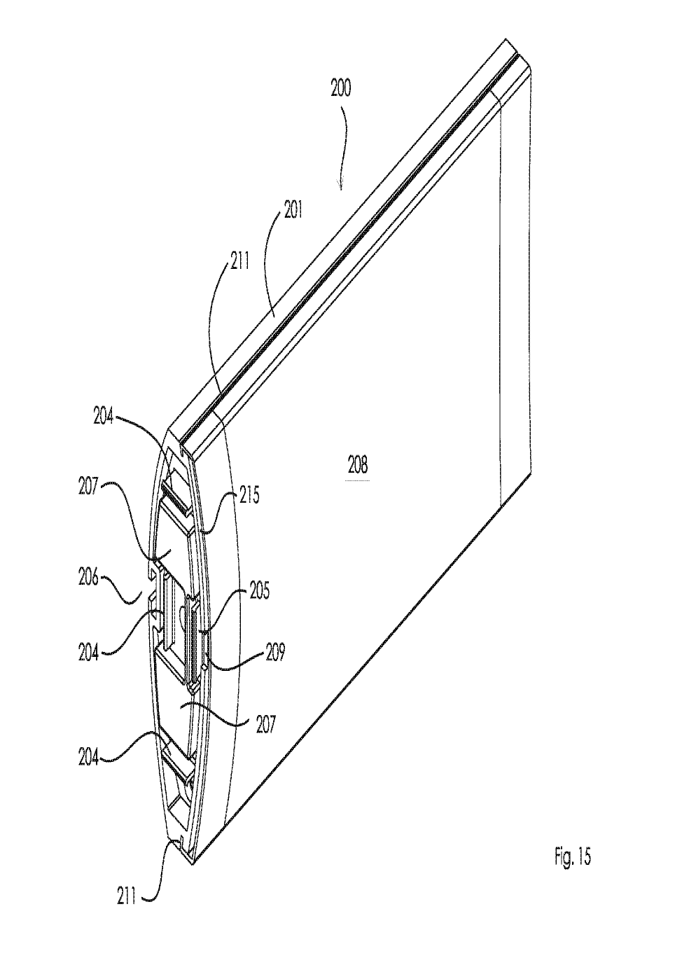

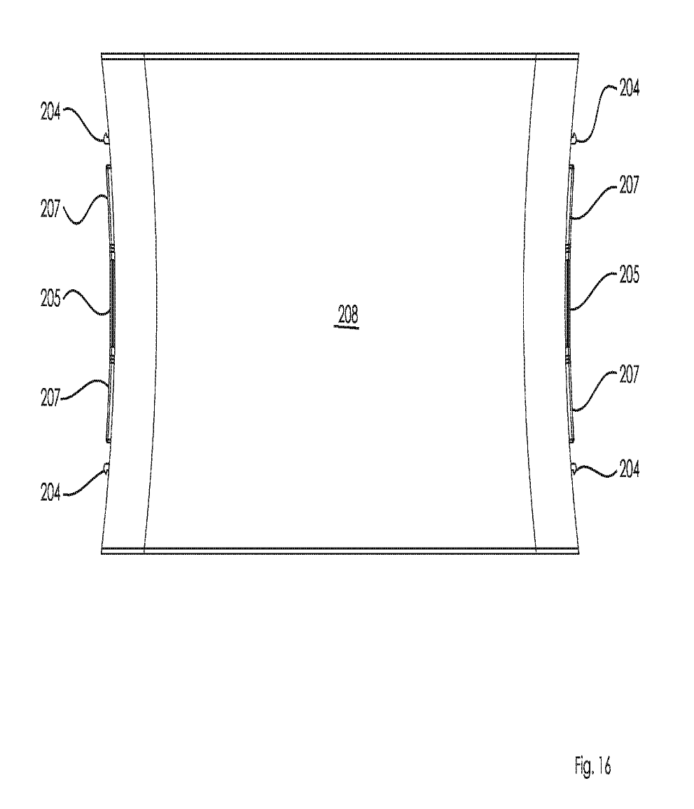

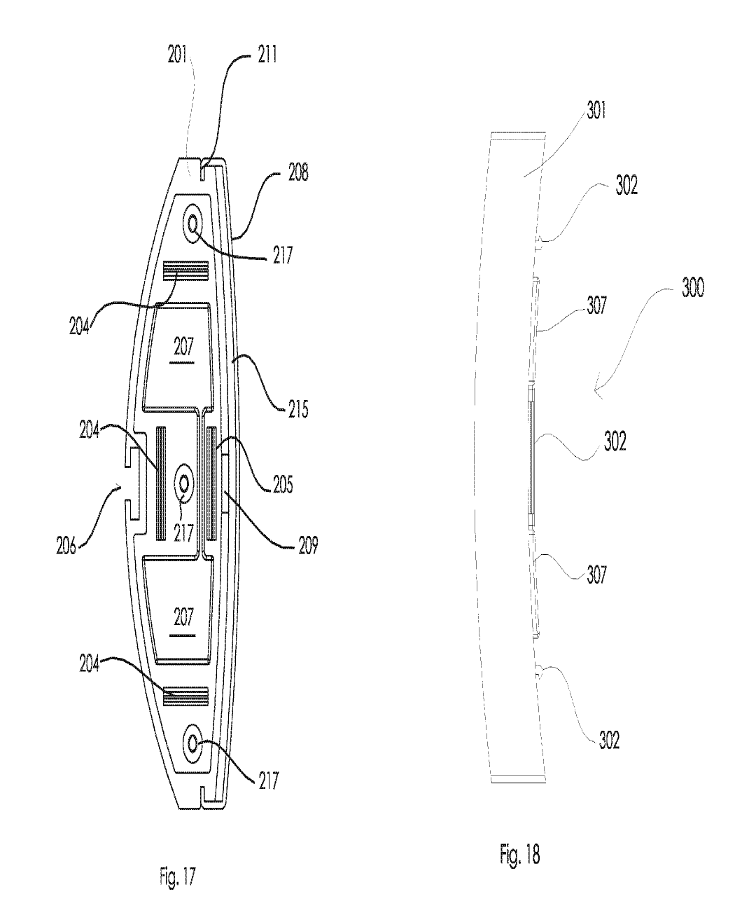

As with the acoustic modules 102, the spacers 200 can include coverings 208. In the presently illustrated embodiments, grooves 211 are included in the casing 201. As seen in FIGS. 15 and 17, these grooves 211 are able to securely accommodate the covering 208. In this embodiment, the module covering 208 is a grill. However, as noted above, other covering types that would be suitable for use with the present invention include, but are not limited to cloth, plastic or metal mesh of any perforation pattern, or no covering at all.

The spacer covering 208 can be made of materials that allow it to blend with the protective covering 104 on the acoustic module 102. For example, it could be made of numerous materials including, but not limited to, hard plastic, ABS, Nylon, PP, perforated aluminum, steel, or stainless steel or combinations thereof. It could also utilize various patterns including, but not limited to meshes, arrays of punched circles, squares, hexagons, or any geometric shape, a series of linear elements, or a random pattern of cutouts. The covering 208 can also include cloth coverings.

As with the acoustic module 102, a small space 215 between the back surface of the covering 208 and the casing 201 can be included—particularly to allow the spacer to blend with the other modules. In some embodiments, additional space may be desirable; in other embodiments, less space may be desirable. In yet other embodiments, the covering 208 may be substantially flush with the casing 201.

Depending on need and desire, in some instances it may be desirable to include the covering 208. However, in some instances, the covering 208 may be eliminated. In yet other cases, combinations of the two may be wanted—i.e. partly covered, partly exposed. In yet other instances, a customized covering rather than the modular covering 208 as depicted in FIGS. 15-17 may be desirable. As discussed above, a full length covering may be desirable for a sound bar configuration.

In this embodiment the grooves 211 are channels in the casing 201 that correspond to the upper and lower edges of the covering 208. However, the covering 208 could be attached to the module 200 in a variety of other ways including, but not limited to screws, magnets, or press fit grooves.

As seen in FIG. 13, each spacer 200 includes a full length T-slot 206 for use with various mounting mechanisms. In the present embodiment, the full length T-slot 206 runs from end to end, and couples with other modules to form a continuous T-slot. In this embodiment, the T-slot 206 is integrated into the casing. However, in other instances, it may be desirable to have the T-slot preformed and then inserted into a corresponding space and then secured to the casing with screws or other known securing mechanisms.

FIG. 14 shows a narrower version of a spacer 210. It is noted that the width of the spacer modules as well as the other modules discussed herein can be adjusted to accommodate a wide variety of configurations depending on need and desire. Referring now to FIGS. 18-21, an end cap module 300 is depicted according to one embodiment of the present invention. The end cap module 300 is designed to provide a finished end to any combination of elements. In this embodiment, the end cap module 300 has a casing 301. The casing 301 can be made of a variety of materials including but not limited to aluminum, ABS, PP, Nylon, PC, PE or combinations thereof. The end cap 300 includes connection mechanisms that correspond to the snap locks 106 in the acoustic modules 102. In this embodiment, the connection mechanisms are a series of tabs 302 having latching ends 303. Again, these are shown in the illustrated embodiment to be oriented in opposite directions relative to one another. However, in other embodiments, it may be desirable to have the orientation be in the same direction. Anchoring devices 307 corresponding with space 111 in the acoustic module 102 can help minimize movement of the modules when connected.

The snap lock and latching tab assemblies are advantageous in that they allow the joining of a plurality of modules in various configurations. However, other connection mechanisms could similarly be employed to secure the end cap module 300 including, but not limited to magnets, screws, and a press fit.

Each end cap module 300 can include a full length T-slot 304 for use with various mounting mechanisms. The T-slot 304 in this embodiment runs through the body of the end cap and can be coupled with other modules to form a continuous T-slot.

The end cap module 300 could, but does not need to include a covering groove. In certain embodiments, the end cap module 300 serves as a stop to keep the coverings (e.g. grills) of other modules contained within the speaker systems when fully assembled.

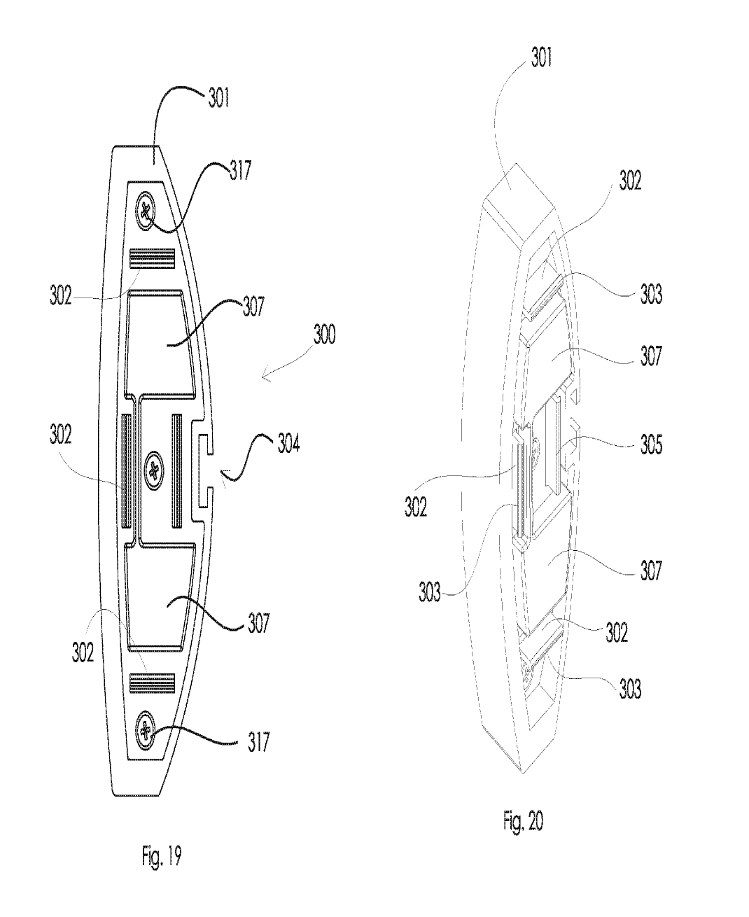

FIG. 19 shows screws 317 that provide a means to secure the plastic snap component into the cosmetic end cap. As noted above, in other instances, the snap components could be manufactured as an integrated part of the end cap and in such embodiments, screws or other fastening mechanisms would not be necessary.

FIG. 21 shows a top view of end cap module 300 according to one embodiment of the present invention.

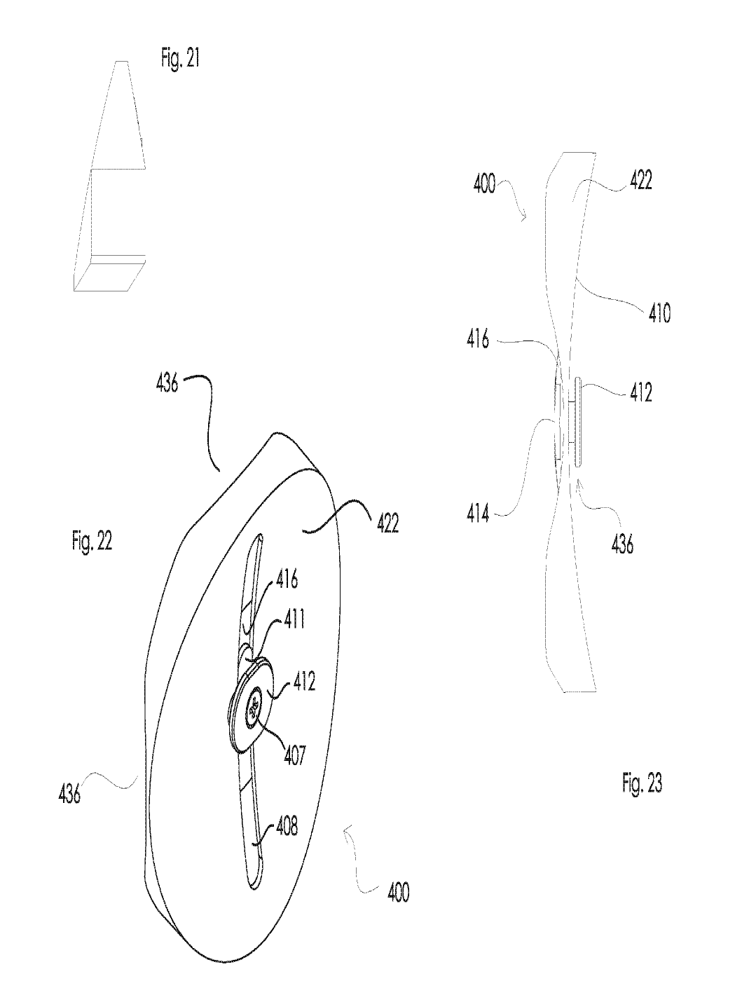

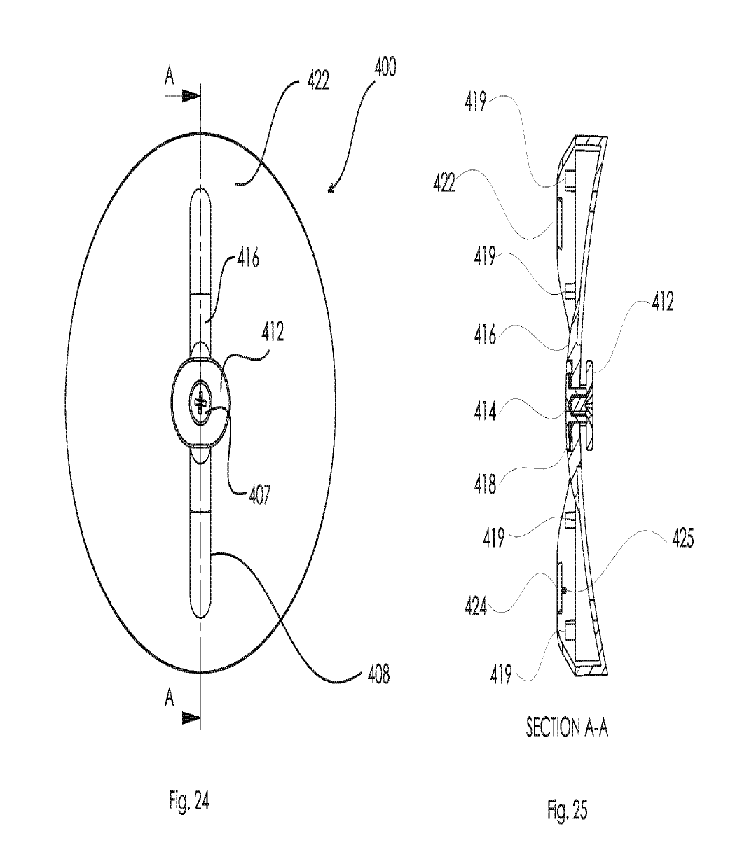

Referring now to FIGS. 22-29, a surface mount assembly 400 is shown according to one embodiment of the present invention. The surface mount assembly 400 provides a solid mounting interface between any substantially planar surface and any module or combination of modules with a T-slot. The surface mount assembly 400 can be constructed of various materials including, but not limited to aluminum, ABS, PC, PP, Nylon and combinations thereof.

The surface mount assembly 400 includes a cradle 422 and a surface mount bracket 420 (FIGS. 27 and 28). The bracket 420 can be attached to a planar surface with numerous connection mechanisms that would be apparent to one skilled in the art including, but not limited to, screws, nails, adhesives and combinations thereof. Holes 401 and slots 403 can be included on the bracket 420 for that purpose. In this embodiment, there are also indicator arrows pointing the correct orientation of the bracket 420.

The surface mount cradle 422 is mounted to the module or system by depressing the button 414 (FIG. 25). This then extends key 412 away from the inside surface of the cradle. The key 412 can then be slid into the continuous T-slot discussed above. The module(s) is then positioned on the cradle where desired and button 414 is released. Shoe 416, which is attached to key 412 with a fastening mechanism 407 such as a screw, can be made of numerous materials including but not limited to nylon, ABS, PP, PC, PTFE, aluminum, zinc, brass, stainless steel, or ceramic. Tabs 411 may be included in shoe 416 to provide a means to keep the assembly from rotating relative to surface mount cradle 422. The wave spring 418 provides tension pulling the module into the cradle. Ribs 419 can also be included to create a proper fit between the surface mount cradle and the surface mount bracket 420. Thus, the cradle is firmly attached to the module or system.

While the spring-loaded button assembly is uniquely advantageous, other suitable mechanisms for fastening the cradle 426 to the module include, but are not limited to bolts, magnets, and a press fit.

In this embodiment, the curved surface 410 of the cradle 426 matches the curvature of the acoustic module 102, the spacer module 200, and the end cap module 300. Moreover, In this embodiment, the surface mount 400 includes a slot 408 to provide approximately +/−15 degrees of rotation in one axis as shown in 430, 432, and 434 (FIG. 29). When rotating the system, shoe 416 provides a stable base for the rotation. The shoe 416 is a component included to provide stability and tension to the surface mount assembly, reducing vibration and maintaining the aimed position. Other stabilizing mechanisms could be utilized including, but not limited to high friction materials, different spring arrangements, or manually adjustable mechanisms using screws.

The curved surface 410 creates the rotation surface for setting the angle between −15 degrees and +15 degrees as shown in 430, 432, and 434. Specifically, in FIG. 29, an illustrative module 405 is shown attached to cradle 422. In this particular example, the slot 408 is oriented in a substantially vertical position. Thus, the module 405 can be rotated in an upward or downward direction. It is noted though that if the cradle 422 was in a horizontal orientation (i.e. with slot 408 in a substantially horizontal position), the module 405 could be adjusted from side to side.

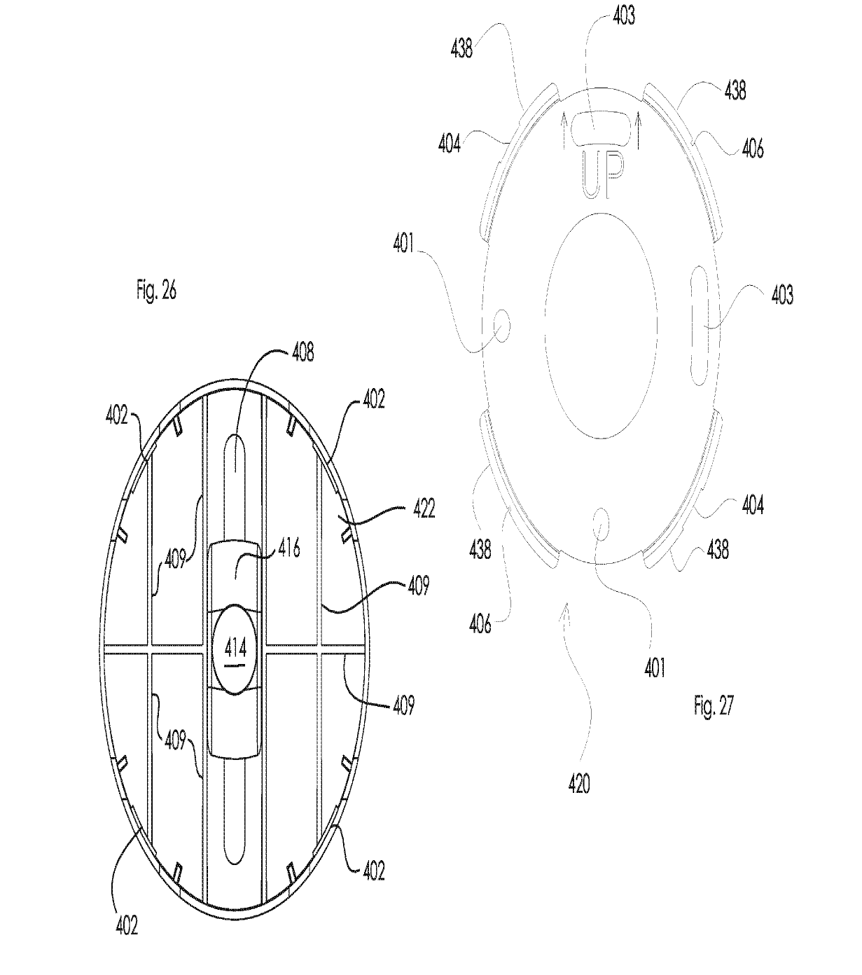

The cradle 422, once connected to the module or system, can then be attached to the surface mount bracket 420. As shown in FIG. 26, the back side of cradle 422 can include locking snaps 402 similar to those already discussed herein. The attachment would be made by pressing cradle 422 toward bracket 420 while aligning snaps 402 with corresponding edges 438 until they engage. For example, the snaps 402 could include a latching tab that engages a groove on the bracket. Other suitable fastening mechanisms that could be utilized include but are not limited to bolts, screws, hooks, pressure fits, or strong magnets. Structural ribbing 409 can also be included to add strength and support to the cradle 422.

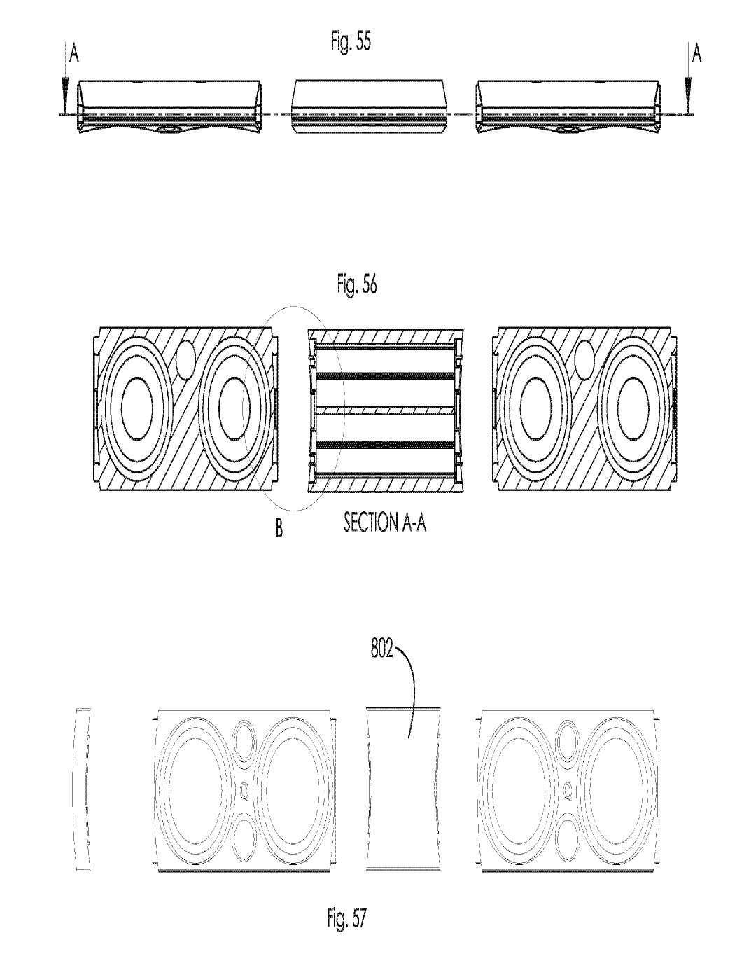

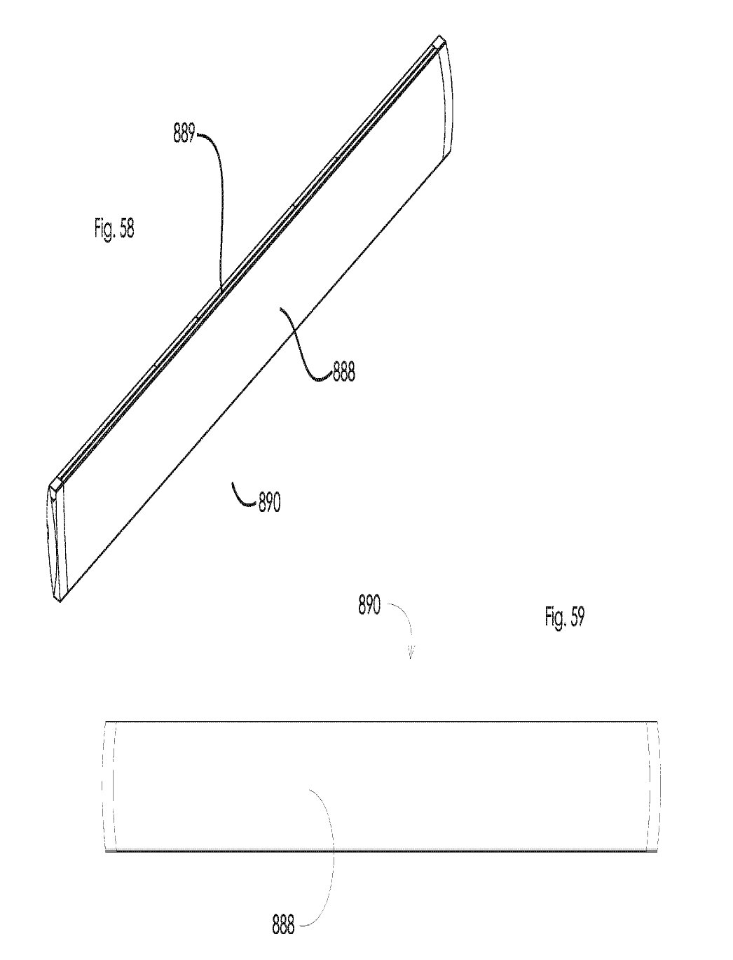

As seen in FIG. 27, the surface mount bracket 420 in this embodiment can include alignment slots. In this embodiment, there are two sets of the slots 404 and 406. Slots 406 are narrow and will capture the alignment key 425 in snap 424 (FIG. 25). The alignment key 425 in this embodiment is a small protrusion that extends from snap 424 Slot 404 is wide and will allow the alignment key 425 to rotate several degrees in either direction. Thus, if the module or speaker system is mounted in a vertical orientation, then snaps 424 connect with slots 406 preventing the system from rotating. If the module or speaker system is mounted in a horizontal orientation, then snaps 424 connect with slots 404, and the system is allowed to rotate several degrees. This rotation allows for some variance which, for example, can be useful when mounting a sound bar (e.g. 850 in FIG. 56) and using two surface mount bracket assemblies 400. Some variability in the alignment of multiple surface mount bracket assemblies is inevitable, and thus the horizontal orientation allows for this variable angle. Vertical installations use a single surface mount bracket assembly, and thus there is no other surface mount bracket assembly to align with, and no need for the angle variability.

The surface mount assembly 400 can also include accommodation for running wires. For example, in this embodiment, wires can be run through windows 436 (FIG. 28). These windows 436 are a narrowing of the cradle 422 thickness thereby providing a gap between the cradle 422 and bracket 420 through which wires and other similar hardware can pass. Other openings and mechanisms could be used to permit the passage of wires including but not limited to holes, slots, detents, or gaps.

Referring now to FIGS. 30-34, the present modular speaker system can include a spine element 500. The spine 500 is designed to provide a continuous vertical support for modules or systems. The spine 500 also creates the stable structure to attach the module or system to either the bookshelf base 600 or the tower base 602 (discussed below).

The spine 500 can include a T-shaped strip 501 that corresponds to the T-slots in the modules (e.g. 108 in FIG. 8). A user would insert the strip 501 into the T-slot and then slide the module down until it met with base 506. In this embodiment, the top 510 of base 506 is sloped to accommodate an endcap module 300 (FIG. 18). Once all the modules are in place, a set screw 520 could be inserted to prevent them from sliding off the spine 500 at the top end. The set screw 520 also reduces vibration. Other suitable mechanisms for locking the module(s) and eliminating vibration include, but are not limited to a tight mechanical fit, additional damping material such as closed cell foam or EVA, or magnets.

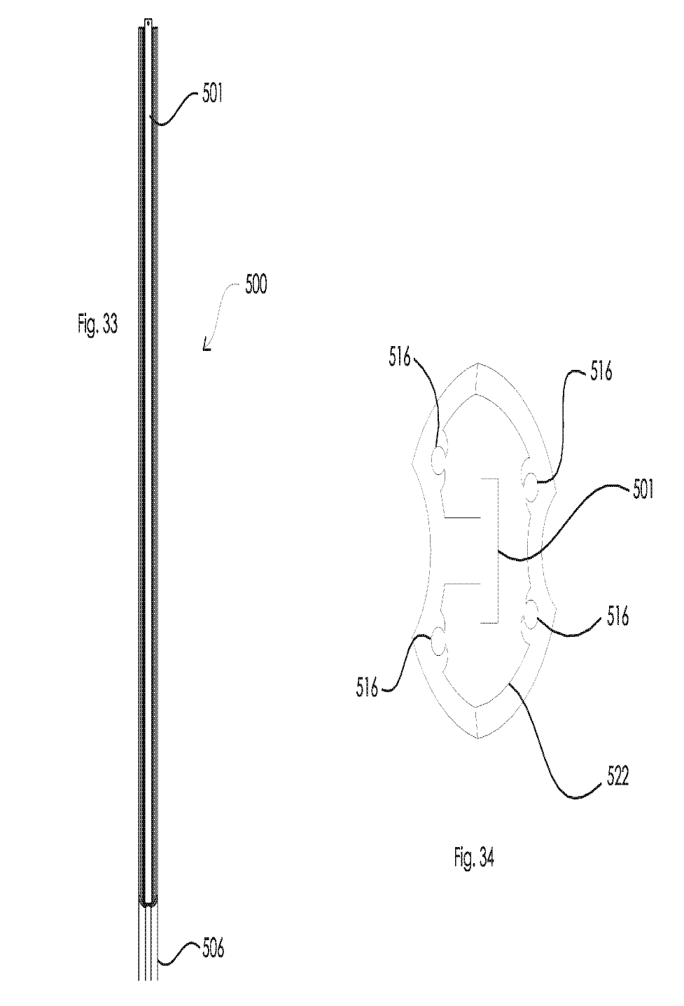

The spine 500 can be made of numerous materials including, but not limited to aluminum, nylon, ABS, PC, PP, steel, stainless steel or combinations thereof. The length, width and depth of spine 500 can vary as illustrated in FIG. 33 to accommodate different combinations of elements. The base 506 of spine 500 can also vary in length to allow the mounted module or system to be positioned at different heights above the floor.

Referring to FIG. 34, a bottom portion of the spine 500 is shown in cross section. This embodiment includes holes 516 for inserting screws, or other attached features to the spine, such as cosmetic end caps, or extensions to the spine.

The profile of spine 500 is, in the present embodiment, designed to interface with the mounting hole 604 in bases 600 and 602 as shown in FIGS. 35-41. The internal profile of spine 500 can also include a channel 522 or other similar space through which wires can be run from acoustic modules 102 to bases 600 and 602.

Referring now to FIGS. 35-38, a bookshelf base 600 is shown. Base 600 provides a solid foundation for vertically oriented, freestanding speaker systems. As noted above, they can include a mounting hole 604 for accepting spine 500 and raised screw holes 634 that correspond with holes 516 in spine 500. In this embodiment, raised screw holes 634 fit inside holes 516 on spine 500 and thereby provide additional stability. In other embodiments, screw holes 634 need not be raised. It is also noted that when the spine is inserted into mounting hole 604, its bottom edge rests on ridge 621. Base 600 can also include binding posts 606 for electrical connection to amplifiers or other electronics. Suitable binding posts 606 include but are not limited to brass threaded posts, chrome threaded posts, spring loaded posts, or simple terminal strips. They may also include other inputs for connection to various sources, including computers, portable media players, etc.

In this embodiment, the top surface 622 of bookshelf base 600 is curved for visual appeal, to increase internal volume, to increase the depth of mounting hole 604, and to provide stiffness. As seen in FIG. 37, the bottom of base 600 can include four domed feet 608. In this embodiment, the feet 608 are custom molded ABS domes, but could be numerous other types of feet that would be apparent to one skilled in the art, including but not limited to brass or steel spikes, or rubber feet. The base 600 can also include a through hole 626. The through hole 626 allows the wires to be run from acoustic modules 102 mounted to spine 500 through base 600.

The bookshelf base 600 can include one or more connectors 612. These connectors 612 serve to provide a place for the wiring from the acoustic module to connect to the base in a hidden fashion. Suitable connectors 612 include, but are not limited to brass or stainless steel threaded binding posts, a custom euro style connector, or a simple terminal strip. In this embodiment, a single connection 612 to one acoustic module 102 is included. Bookshelf base 600 can also include a channel 628 for the wire to recess into and a recess 610 for an Allen wrench that can be used in assembling the system.

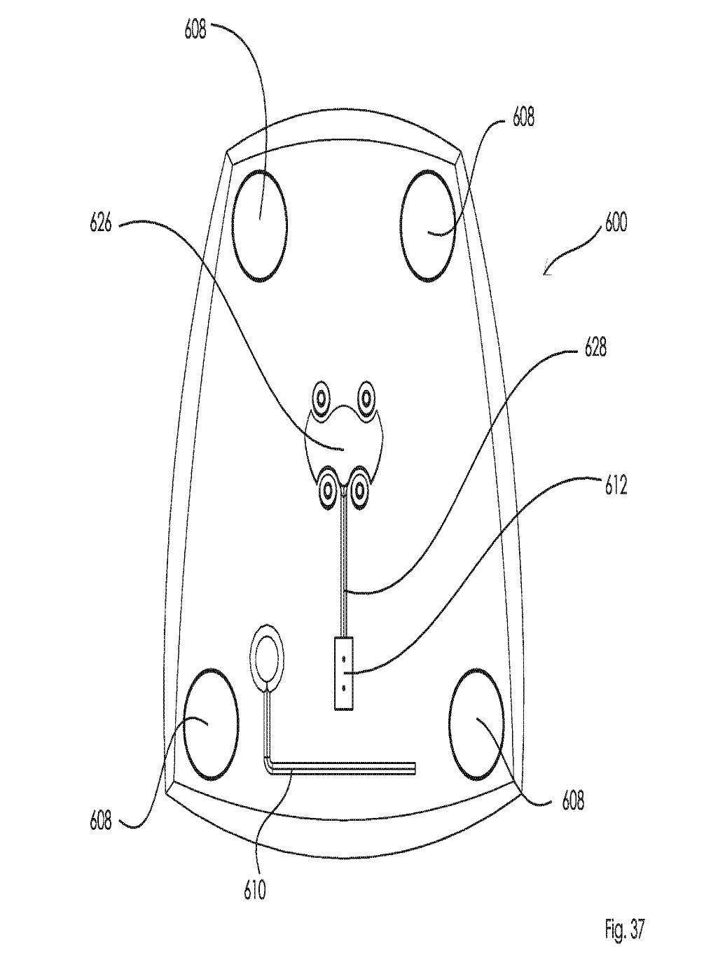

Referring now to FIGS. 39-41, tower base 602 similarly provides a solid foundation for vertically oriented, freestanding speaker systems. Tower bases 602 can include a mounting hole 605 for accepting spine 500. Base 602 can also include binding posts 607 for electrical connection to amplifiers or other electronics. Suitable binding posts 607 include but are not limited to brass threaded posts, chrome threaded posts, spring loaded posts, or simple terminal strips. They may also include other inputs for connection to various sources, including computers, portable media players, etc.

The top surface 621 of tower base 602 can be curved for visual appeal, to increase internal volume, to increase the depth of mounting hole 605, and to provide stiffness. It is noted that in some situations, it may be desirable to increase the curvature of the top surface 621 of tower base 602 even further than in bookshelf base 600. This provides a deeper mounting hole and added stability for taller systems. Mounting hole 605 can also include one or more raised screw holes 635 that correspond with screw holes 516 on the spine 500. In this embodiment, raised screw holes 635 fit inside holes 516 on spine 500 and thereby provide additional stability. In other embodiments, screw holes 635 need not be raised. It is also noted that when the spine is inserted into mounting hole 605, its bottom edge rests on ridge 623.

The bottom of tower base 602 can similarly include four domed feet 609. In this embodiment, the feet 609 are custom molded ABS domes, but could be numerous other types of feet that would be apparent to one skilled in the art, including brass or steel spikes, or rubber feet. The base can also include a through hole 625 that allows wires to be run from acoustic modules 102 mounted to spine 500 through base 602.

Tower base 602 in this embodiment includes three connectors 614, 616, and 618 for connections to up to three acoustic modules 102. The tower base 602 in this embodiment also includes three channels 630 for the wires to recess into. The number of connectors could vary depending on need and/or desire. Connectors 614, 616, and 618 can also be different types and shapes to allow for addressing specific acoustic modules 102.

Referring now to FIGS. 42-49, various examples and applications of the modular system are shown. These figures are not intended to limit the scope of the invention claimed herein. Rather, they are merely intended to provide illustrations of certain exemplary usages. Numerous other combinations of the components are considered to be within the scope of the present invention.

In FIGS. 42-47, a bookshelf speaker 700 can be assembled using two endcap modules 706 and 716, one acoustic module 708, one bookshelf spine 710, one bookshelf base 714, and one spine endcap 712

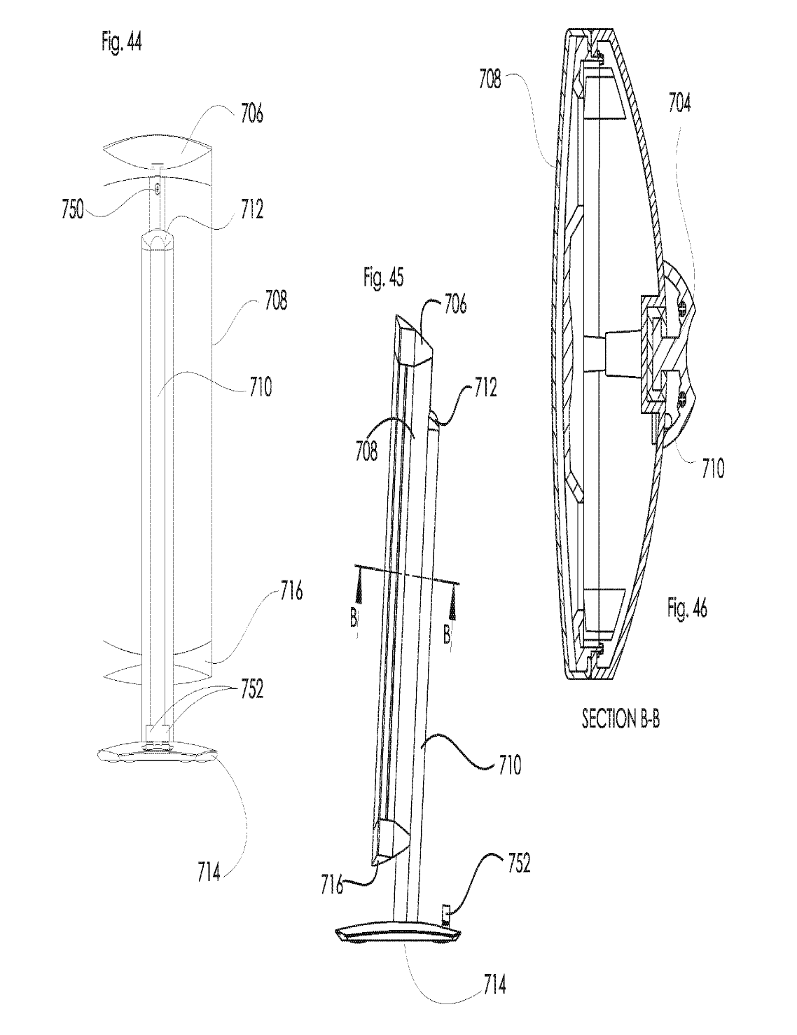

Acoustic module 708 is first snapped together with endcap modules 706 and 716. The wire (not shown) is then connected to the back of acoustic module 708. The resulting assembly is then slid onto spine 710 with the T-slot interfacing with the spine 710 as shown at 704 (FIG. 46). Set screw 750 is then tightened to lock the speaker assembly onto the spine 710. In this embodiment, the wire is fed through a hole in bookshelf base 714, and connected to connector 738. Four screws are threaded through bookshelf base 714, and into spine 710 to lock it into place. Endcap 712 is pressed into the top of spine 710. Wires can then be connected from inputs 752 to the source.

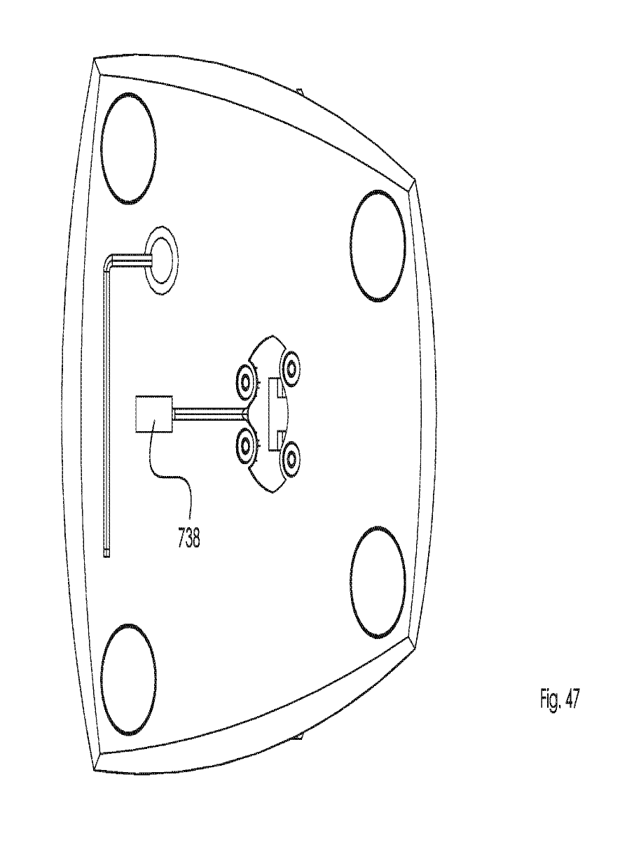

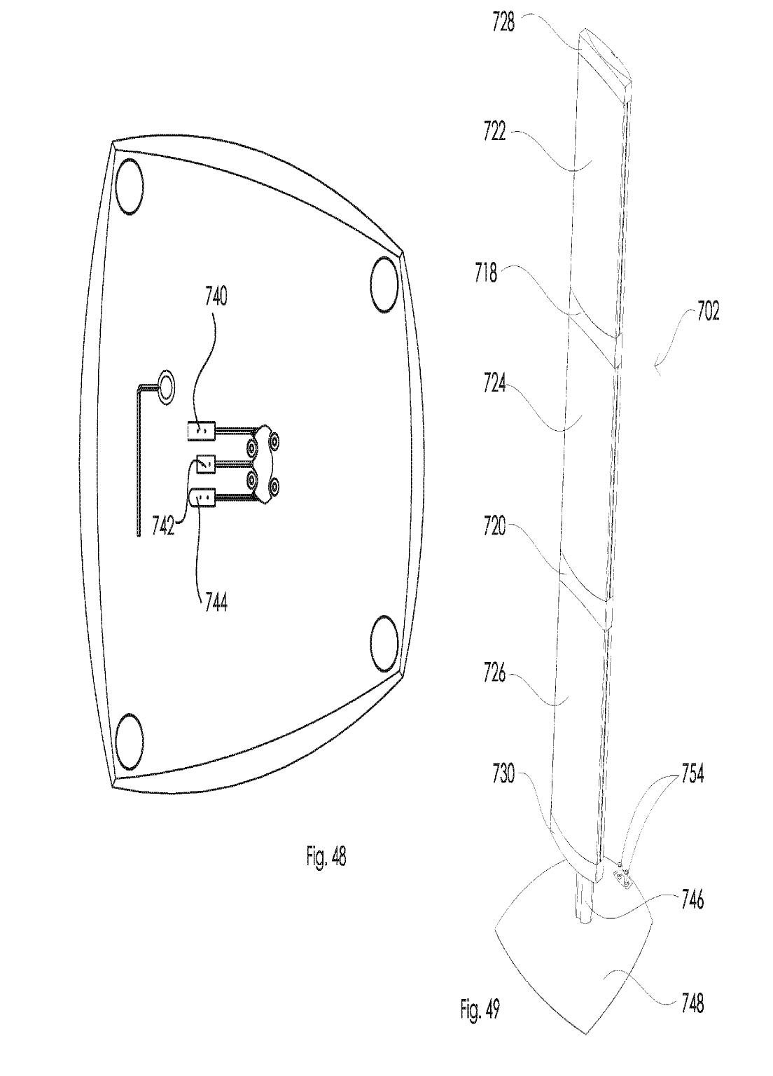

Referring now to FIGS. 48-49, a tower speaker 702 can be assembled using two endcap modules 728 and 730, three acoustic modules 722, 724, and 726, two short spacer modules 718 and 720, one tower spine 746, and one tower base 748.

Acoustic modules 722, 724, and 726 are connected with spacer modules 718 and 720. Endcap modules 728 and 730 are then snapped onto the ends. Wires are connected to the three acoustic modules 722, 724, 726 and the assembly of modules 722, 724, and 726, spacers 718 and 720, and endcaps 728 and 730 is then slid onto spine 746 with the wires inside the spine. The set screw shown in 750 is then tightened to lock the speaker assembly onto the spine. In this embodiment, the wires are fed through the hole in tower base 748, and connected to connectors 740, 742, and 744 (FIG. 48). Four screws are threaded through tower base 748, and into spine 746 to lock it into place. An endcap (similar to that shown at 712) is pressed into the top of spine 746. Wires can then be connected from inputs 754 to the source.

Referring now to FIGS. 50-59, a sound bar 892 can be assembled with two endcap modules 866 and 878, three acoustic modules 868, 872, and 876, and two spacer modules 870 and 874. Two surface mount kits 884/880 and 886/882 are used to mount the sound bar 892 to the surface.

Components 866, 868, 870, 872, 874, 876, and 878 are all snapped together using snaps 808 and 810. Guides 814 and 812 ensure that the parts snap together smoothly. Guides 814 and 812 also provide support to the structure so the snaps 808 and 810 don't have to bear the majority of the load. In this illustration, the acoustic module 801 has a snap locking mechanism 810 that works in conjunction with a latching tab 808 on spacer 803. When the two modules are pressed together, the tab 808 has a certain amount of pliability and bends downward until latching end 809 comes into contact with groove 811 at which point, tab 808 rebounds and the positioning of end 809 in groove 811 holds modules together until tab 808 is pressed downward thereby disengaging latching end 809 from groove 811.

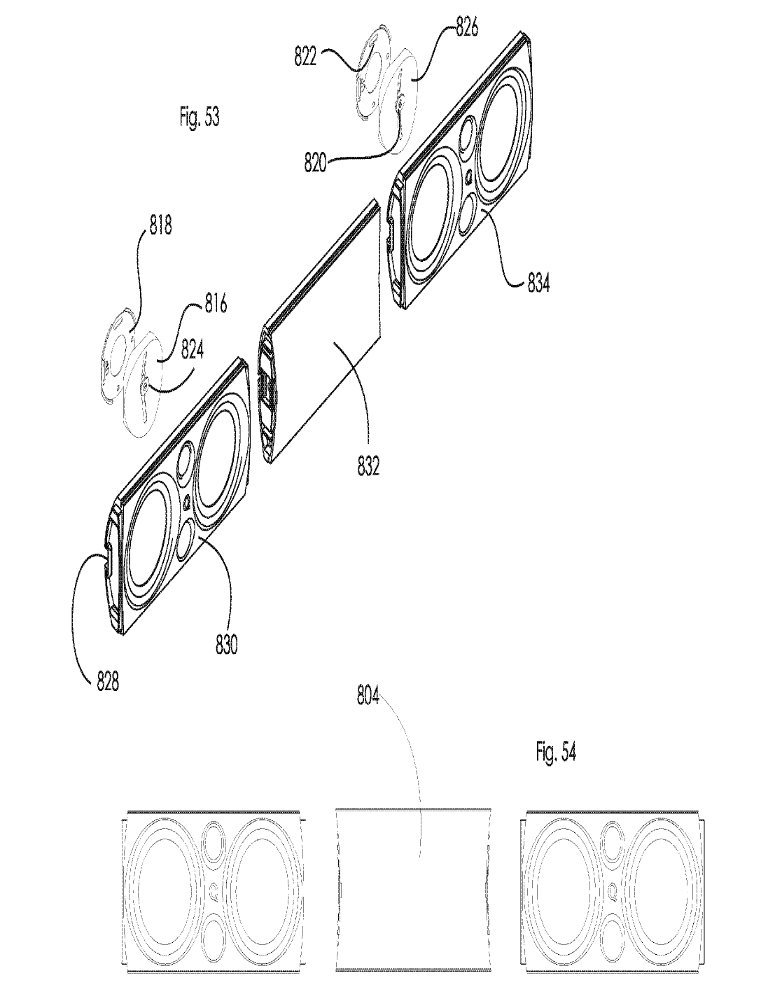

Referring now to FIG. 53, each surface mount cradle 816 and 820 is attached to the sound bar assembly as outlined in FIGS. 22-29, with keys 824 and 826 sliding into the continuous T-slot 828. Each surface mount bracket 818 and 822 is attached to the surface. The sound bar assembly is snapped onto the surface mount brackets 818 and 822 and can then be aimed +/−15 degrees as shown in 430, 432, and 434 (FIG. 29).

As seen in FIGS. 54-57, the sound bar can be created in any width to match the width of the TV or decor by using spacers with the proper width. Wider spacers like 804 will yield a longer sound bar 892. Likewise, narrower spacers like 802 will yield a narrower sound bar. This adaptability allows a user to construct a sound bar that matches the width of any electronic device, furniture, appliance, or architectural feature.

For a custom appearance, the grills or coverings included with acoustic modules and spacers can be removed in whole or in part. A custom grill 888 (FIGS. 58-59) can also be added in the length necessary to span the sound bar 890 based on the width of acoustic modules and spacers. The custom grill 888 is then attached to the continuous grill grooves 889 and the sound bar 890 is complete.

Referring to FIGS. 60-65, an on wall speaker 900 may be created using one acoustic module 904 and two endcap modules 902 and 906. A surface mount assembly 910 and 912 allows the speaker 900 to be attached to a surface such as wall. A stopper 908 can also be included. In this embodiment, the stopper 908 is a small part designed to fit in the t-slot 916, and be locked down with a small screw or other similar fastening mechanism that would be apparent to one skilled in the art.

The purpose of the stopper 908 is to keep the speaker assembly 900 from sliding off the surface mount assembly 910, 912. The stopper 908 can be constructed of various materials including, but not limited to stainless steel, carbon steel, brass, ABS, PC, PP, PE, nylon or combinations thereof. In other embodiments, the stopper function can be accomplished by a set screw or other similar mechanism.

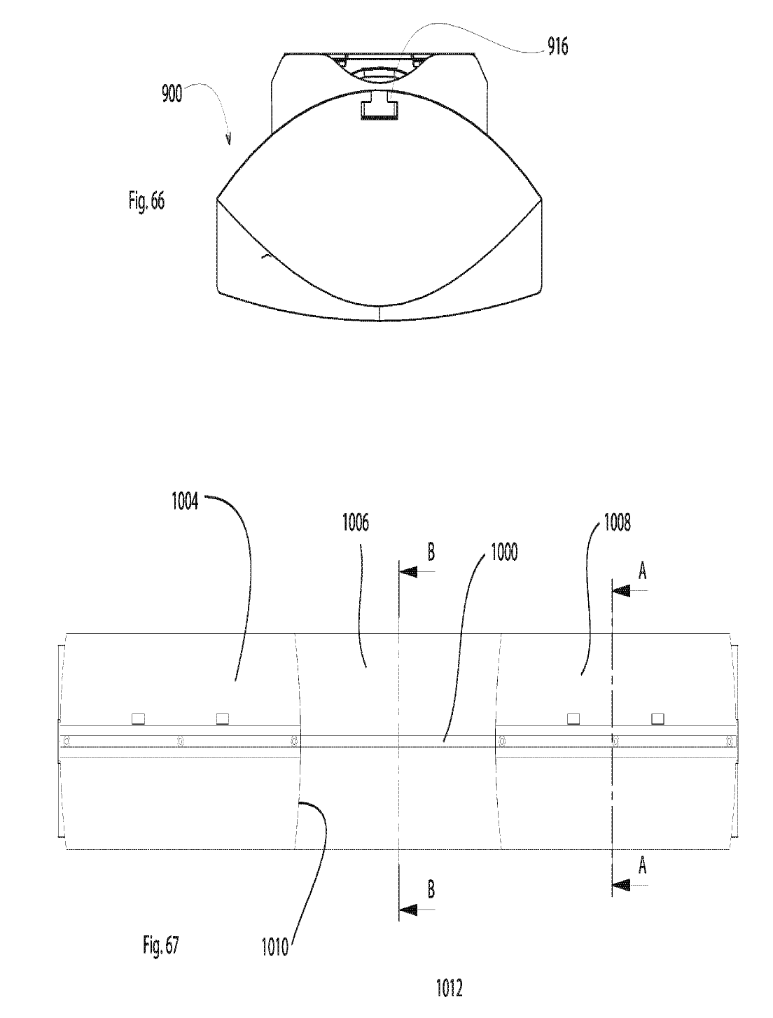

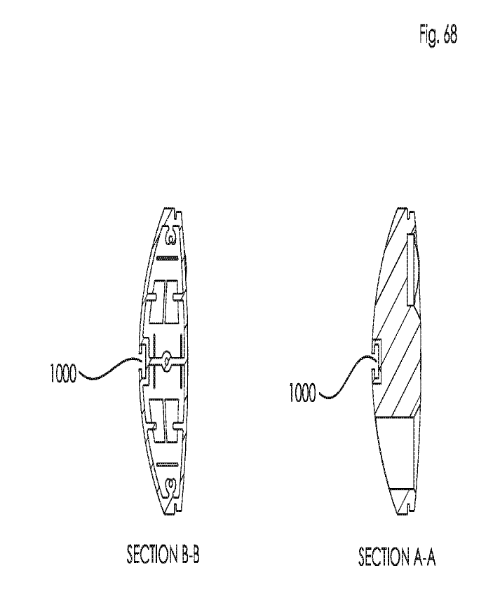

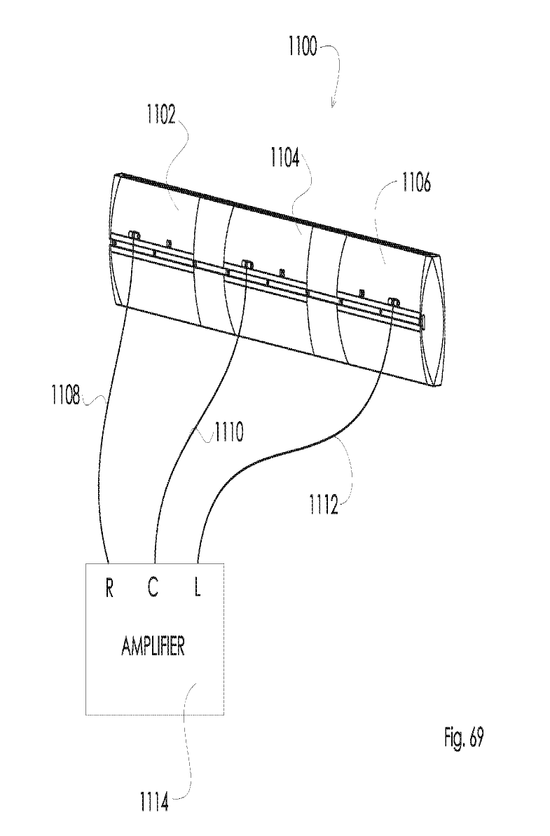

The two endcap modules 902 and 906 are snapped onto the acoustic module 904. Stopper 908 is then slid into the continuous T-slot 916, and locked into place using the set screw at the chosen position 922 near the center of the acoustic module 904. Surface mount cradle 910 is then attached to the system as discussed previously and slid on until it makes solid contact with stopper 908. Surface mount bracket 912 is attached to the surface. The speaker system is then snapped onto surface mount bracket and the installation is complete. FIG. 66 shows a top perspective view of the speaker 900 secured to the cradle bracket assembly 910, 912 through T-slot 916.

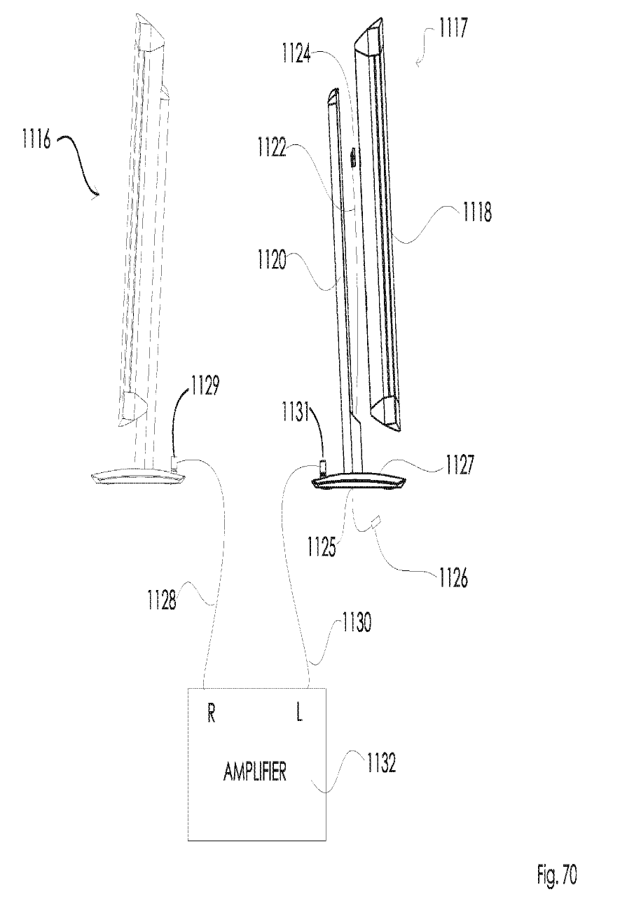

Referring to FIGS. 67-68, the continuous T-slot 1000 for mounting various structures to the modules is shown according to one embodiment of the present invention. The structures include, but aren't limited to, the surface mount kit and spines. The T-slot can be included in all acoustic modules 1004, all spacer modules 1006, and all endcap modules (not shown). By having a uniform slot, continuity between modules as shown in 1010 and 1012 can be easily accomplished. The continuous T-slot may either be molded into the structure of the module as in spacer modules (Section B-B), or may be a separate part attached to the module as in acoustic module (Section A-A).

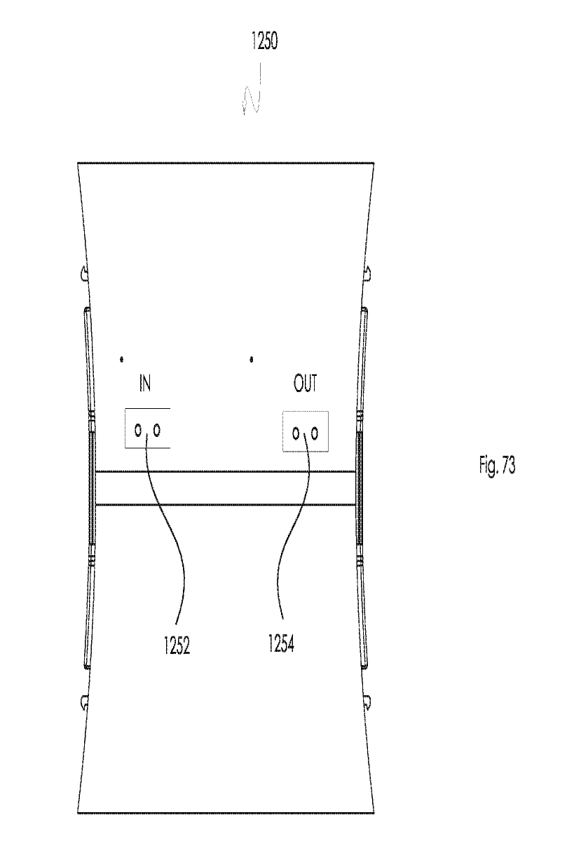

FIGS. 69-73 depicts exemplary wiring configuration for speaker assemblies according to one embodiment of the present invention. It is however noted that the presently disclosed configuration is intended to illustrate the function of the invention and is not intended to limit its scope.

In this example, the sound bar 1100 is designed to act as three separate channels. Typically these would make up the left center and right channels of a surround sound system. To connect sound bar 1100 to a typical amplifier, one would run wire 1112 from the input of left acoustic module 1106 to the left output of amplifier 1114. Likewise, one would run wire 1110 from the input of the center acoustic module 1104 to the center output of amplifier 1114. Finally, one would run wire 1108 from the input of right acoustic module 1102 to the right output of amplifier 1114. In this configuration, sound bar 1100 is fully connected to perform the duties of the left, center, and right channels of a typical multi channel sound system.

It is noted that in this embodiment, the wire is copper speaker wire. However, numerous other wire types could be used in connection with the present invention including, but not limited to shielded speaker wire, aluminum wire, or silver wire.

Bookshelf speakers 1116 and 1117 are designed to act as mono speakers with a single input each from amplifier 1132. Two stages of wiring are necessary, first connecting the acoustic module 1118 to the base 1127, then connecting the amplifier 1132 to the binding posts 1129 and 1131. To electrically connect acoustic module 1118 to base 1127, first connector 1124 of cable 1122 is plugged into one of the two input connectors on the back of acoustic module 1118. Then, cable 1122 is run through hole 1125 in base 1127. After this connection, acoustic module assembly 1118 is slid into place on spine 1120 as described above. Once acoustic module assembly 1118 is affixed to spine 1120, then connector 1126 is plugged into the receptacle in the bottom of base 1127. Bookshelf speaker 1117 is now wired as a mono speaker.

To connect bookshelf speaker 1117 to amplifier 1132, wire 1130 can be connected to input binding posts 1131 on base 1127. Wire 1130 is then connected to the left channel of amplifier 1132. Likewise, to connect bookshelf speaker 1116 to amplifier 1132, wire 1128 is connected to binding posts 1129 on speaker 1116. Wire 1128 is then connected to the right channel of amplifier 1132. The bookshelf speakers are now wired as a stereo pair.

Tower speakers 1134 and 1135 are designed to act as mono speakers with a single input each from amplifier 1162. Two stages of wiring are necessary, first connecting the acoustic modules 1136, 1138, and 1140 to base 1161, then connecting the amplifier 1162 to binding posts 1167 and 1165.

To electrically connect acoustic modules 1136, 1138, and 1140 to base 1161, first connector 1150 is plugged into one of the inputs in the back of acoustic module 1136. The connector 1152 is plugged into one of the inputs in the back of acoustic module 1138. Finally, connector 1154 is plugged into one of the inputs in the back of acoustic module 1140. Then, cables 1144, 1146, and 1148 are run through hole 1149 in base 1161.

At this point, the assembly of acoustic modules 1136, 1138, and 1140 along with the spacers and end caps is slid in place on spine 1142. It can be fixed in place as described previously. Once the acoustic modules are affixed to spine 1142, then connectors 1156, 1158, and 1160 are plugged into the bottom of base 1161.

Connectors 1156, 1158, and 1160 can be a variety of different types and shapes. Similarly, cables 1144, 1146, and 1148 can be different lengths. This helps ensure that each acoustic module is individually addressed within the electronic circuit inside base 1161.

Tower speaker 1135 is now wired as a mono speaker. To connect tower speaker 1135 to amplifier 1162, wire 1168 is connected to input binding posts 1167 on base 1161. Wire 1168 is then connected to the left channel of amplifier 1162. Likewise, to connect tower speaker 1134 to amplifier 1162, wire 1164 is connected to binding posts 1165 on speaker 1134. Wire 1165 is then connected to the right channel of amplifier 1162. The tower speakers are now wired as a stereo pair.

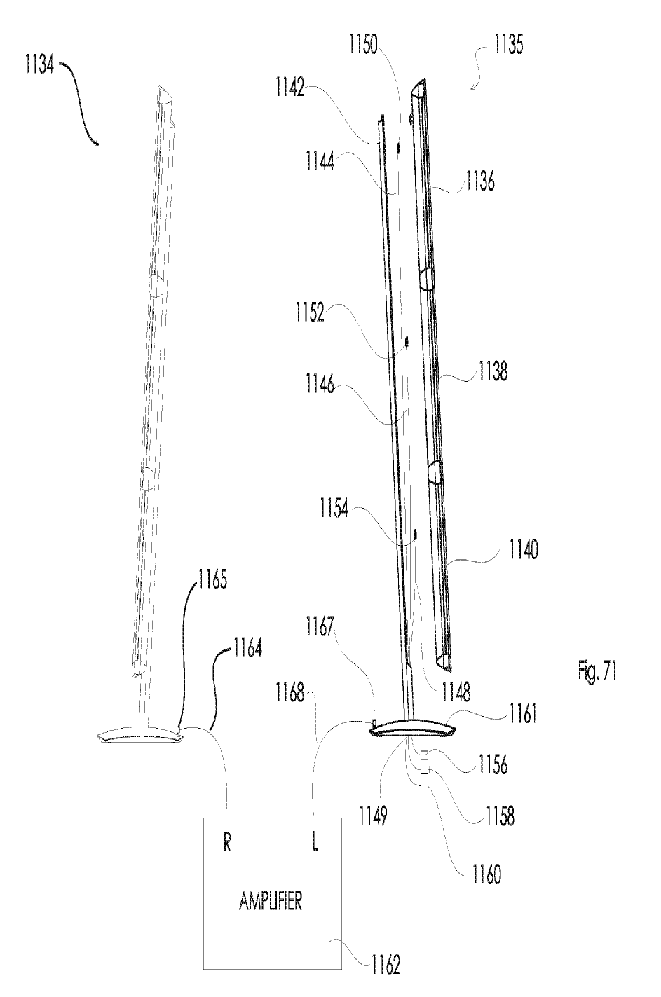

Referring to FIG. 71, in this embodiment, one channel from amplifier 1208 is connected to the input of the central acoustic module 1178 with wire 1206. Acoustic module 1178 is mechanically attached to array module 1184, which is then attached to acoustic module 1176. Acoustic module 1176 then connects to array module 1174, which finally mechanically connects to acoustic module 1172. Moving in the other direction, acoustic module 1178 mechanically connects to array module 1186, which connects to 1180. Acoustic module 1180 then mechanically connects to array module 1188, which finally terminates with acoustic module 1182.

In addition to the mechanical connections between all modules, electrical connections are made to transfer the signal. Acoustic module 1178 connects to array module 1184 via connector 1196. Suitable connectors 1196 include, but are not limited to euroblock connectors, terminal strips, and binding posts. Array module 1184 then processes the signal as necessary, including delay and tone shaping. Array module 1184 outputs the processed signal via connector 1194, which connects to the input of acoustic module 1176. Again, acoustic module 1176 connects to array module 1174 via connector 1192. Array module 1174 processes the signal, and outputs it via connector 1190 to acoustic module 1172.

The same happens in the other direction from acoustic module 1178 through connector 1198 into array module 1186. Then through connector 1200 to acoustic module 1180 and back out connector 1202 into array module 1188. Finally, array module 1188 sends the processed signal out through connector 1204 to acoustic module 1182.This chain of signal processing serves to create an electrically shaped line array. This creates mono line array 1170, which connects to one channel of amplifier 1208.

Array 1171 is mechanically identical to array 1170, but uses spacer modules instead of array modules. Central acoustic module 1232 mechanically connects to spacer 1230, which in turn connects to acoustic module 1228. Acoustic module 1228 connects to spacer 1226, which finally connects to acoustic module 1224. In the other direction, acoustic module 1232 connects to spacer 1234, which connects to acoustic module 1236. Acoustic module 1236 connects to spacer 1238 which finally connects to acoustic module 1240. To create the electrical circuit, array 1171 relies on a single processing module 1212 as opposed to the individual array modules of array 1170.

Signal processing module 1212 performs the same delay and tone shaping duties as the array modules described above, but all circuitry is located in a central enclosure, with wires running to each acoustic module. In this instance, no array modules are necessary between acoustic modules, and simple spacer modules are used. Acoustic modules 1224, 1228, 1232, 1236, and 1240 in array 1171 connect directly to a specific output of signal processing module 1212 via wires 1222, 1220, 1218, 1214, and 1216 respectively. Signal processing module 1212 connects to one channel of amplifier 1208 via wire 1210, and delays the signal and adjusts the tone of each output going to the acoustic modules. Array 1171 and 1170 have identical electrical performance and characteristics, just different implementations.

Other speaker systems can be assembled from the foregoing modules, such as line arrays, LC/CR speaker systems, multi channel sound bars, etc. Other modules can be incorporated into this system such as amplifier modules, array shaping modules, angle changing modules, and different acoustic modules. Other mounting kits are possible using the continuous T-slot including ceiling mounts, surface mounts with 0 degrees of adjustability, surface mounts with higher degrees of adjustability, surface mounts with rotation in the other axes, etc. The modular system lends itself to expansion as time progresses.

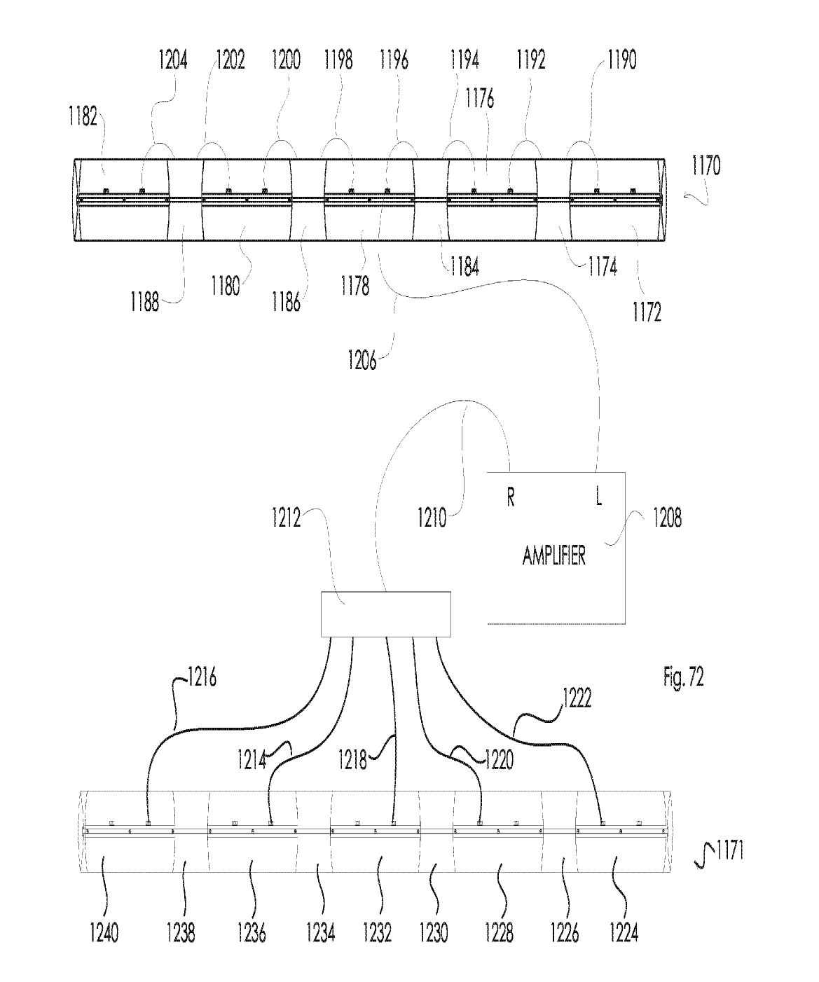

A plurality of acoustic modules can be connected together with enough spacers, or array modules and end caps to form an array. In embodiments 1170 and 1171, five acoustic modules are used as examples. Array 1170 uses array modules between each acoustic module. As seen in FIG. 72, the array module 1250, according to one embodiment of the present invention, is a spacer module which includes the addition of array shaping electronics inside. Its purpose is to delay the signal, and shape the tone as the signal propagates out through the system. It maintains the aesthetics, construction, and mechanical function of the spacer module, but with the addition of input connector 1252 and output connector 1254. The signal is fed from one acoustic module into the array module input 1252, runs through the internal circuitry, and back out the output connector 1254. Output connector 1254 connects to the next acoustic module in the array. Inside the array module is an electronic circuit that, in its passive form, uses an all-pass network to delay the full range signal, and may also include any combination of high pass, low pass, band pass, shelving, and notch filters. An alternate construction of an active array module includes active circuitry inside which implements a specific full range delay in addition to any combination of high pass, low pass, band pass, shelving, and notch filters, as well as equalization of audio frequencies from 20 Hz to 20 kHz. Finally, a third embodiment of an active array module includes DSP to implement the specific full range delay for array shaping. The DSP may also include any combination of high pass, low pass, band pass, shelving, and notch filters, as well as equalization of audio frequencies from 20 Hz to 20 kHz.

It is understood that the above-described arrangements are only illustrative of the application of the basic principles of the present invention. Numerous modifications and alternative arrangements may be devised by those skilled in the art without departing from the spirit and scope of the present invention. For example, each application may differ depending on the current architecture of the building. If no metal fascia and soffit is available, an altered design would be used to attach the channel to the building through the use of a detachable clip or a fastener system.

What is claimed is:

1) A customizable modular speaker system comprising:
a) one or more acoustic modules;
b) one or more optional spacer modules coupled to the one or more acoustic modules; and
c) one or more end caps capable of being coupled to the one or more acoustic modules or the one or more spacer modules.

2) The system of claim 1, wherein the acoustic modules, the optional spacer modules and the end caps include a substantially continuous T-slot.

3) The system of claim 2, wherein the T-slot is capable of engaging a wall mounting cradle.

4) The system of claim 3, wherein the wall mounting cradle is attached to a surface with a mounting bracket.

5) The system of claim 2, wherein the T-slot is capable of engaging a spine.

6) The system of claim 5, further comprising a base capable of engaging the spine.

7) The system of claim 6, wherein the base includes one or more electrical connectors capable of relaying an electrical signal from an amplifier to the acoustic modules.

8) The system of claim 6, wherein the base engages the spine with a mounting hole.

9) The system of claim 1, wherein the modules are assembled into a bookshelf speaker.

10) The system of claim 1, wherein the modules are assembled into a tower speaker.

11) The system of claim 1, wherein the modules are assembled into a sound bar.

12) The system of claim 1, wherein the modules are assembled into a wall speaker.

13) The system of claim 1, wherein the acoustic modules include a covering.

14) The system of claim 13, wherein the covering is a grill.

15) The system of claim 1, wherein the optional spacers include a covering.

16) The system of claim 15, wherein the covering is a grill.

17) The system of claim 1, wherein the acoustic modules, the optional spacer modules and the end caps create a continuous covering groove.

18) The system of claim 1, wherein the acoustic modules, the optional spacer modules and the end caps are connected with one or more snap lock assemblies.

19) The system of claim 1, wherein the acoustic modules and the optional spacer modules form a line array.

20) The system of claim 3, wherein the cradle releasably attaches to the T-slot.
